(19) United States
(12) Patent Application Publication
(10) Pub. No.: US 2025/0355200 A1
(43) Pub. Date: Nov. 20, 2025

(54) SECURE ATTACHMENT OF OPTICAL COUPLING DEVICE

(71) Applicant: Intel Corporation, Santa Clara, CA (US)

(72) Inventors: Darren Vance, Gilbert, AZ (US); Sufi R. Ahmed, Chandler, AZ (US); Peter A. Williams, Phoenix, AZ (US)

(73) Assignee: Intel Corporation, Santa Clara, CA (US)

(21) Appl. No.: 18/622,563

(22) Filed: Mar. 29, 2024

(51) Int. Cl. G02B 6/42

(52) U.S. Cl. CPC G02B 6/4239; G02B 6/4268

(57) ABSTRACT

An apparatus comprising a die comprising a photonic integrated circuit, the die comprising a first plurality of optical channels; an optical coupling device, the optical coupling device comprising a second plurality of optical channels aligned with the first plurality of optical channels; and a coupler attached to the optical coupling device and to at least one of the die and a package substrate attached to the die.

### GOVERNMENT RIGHTS

This Invention was made with Government support under Agreement No. N00164-19-9-0001, awarded by NSWC Crane Division. The Government has certain rights in the Invention.

### BACKGROUND

High-speed optical interconnects are crucial to meet the continuously increasing data rate demands of modern data centers and computing systems. Computing components may be packaged with optical interfaces to enable them to communicate over high-speed optical interconnects rather than traditional electrical interconnects. An optical interface typically includes a photonic integrated circuit (PIC) to send and receive optical signals over optical channels.

### BRIEF DESCRIPTION OF THE DRAWINGS

FIG. 1 illustrates an exploded view of a package comprising a photonic integrated circuit (PIC) and discrete coupling features, in accordance with any of the embodiments disclosed herein.

FIG. 2 illustrates the package of FIG. 1, in accordance with any of the embodiments disclosed herein.

FIG. 3 illustrates an exploded view of a PIC and a coupling feature having an open cavity, in accordance with any of the embodiments disclosed herein.

FIG. 4 illustrates the PIC and coupling feature of FIG. 3, in accordance with any of the embodiments disclosed herein.

FIG. 5 illustrates a package comprising a PIC and a coupling feature having a closed cavity, in accordance with any of the embodiments disclosed herein.

FIG. 6 illustrates the package of FIG. 5, in accordance with any of the embodiments disclosed herein.

FIG. 7 illustrates an exploded view of a PIC and a coupling feature with a closed cavity and extended sides, in accordance with any of the embodiments disclosed herein.

FIG. 8 illustrates the PIC and coupling feature of FIG. 7, in accordance with any of the embodiments disclosed herein.

FIGS. 9A-9D illustrate various coupling features and PICs, in accordance with any of the embodiments disclosed herein.

FIG. 10 illustrates a system comprising a package comprising a PIC and a coupling feature, in accordance with any of the embodiments disclosed herein.

FIG. 11 provides a schematic illustration of a cross-sectional view of an example integrated circuit device, in accordance with any of the embodiments disclosed herein.

FIG. 12 is a top view of a wafer and dies that may be included in a microelectronic assembly, in accordance with any of the embodiments disclosed herein.

FIG. 13 is a cross-sectional side view of an integrated circuit device that may be included in a microelectronic assembly, in accordance with any of the embodiments disclosed herein.

FIG. 14 is a cross-sectional side view of an integrated circuit device assembly that may include a microelectronic assembly, in accordance with any of the embodiments disclosed herein.

FIG. 15 is a block diagram of an example electrical device that may include a microelectronic assembly, in accordance with any of the embodiments disclosed herein.

### DETAILED DESCRIPTION

High-speed optical interconnects are crucial to meet the continuously increasing data rate demands of modern data centers and computing systems. For example, computing components (e.g., processors, accelerators, field programmable gate arrays (FPGAs), switches, memory/storage, other application specific integrated circuit (ASIC) nodes) may be packaged with optical interfaces to enable them to communicate over high-speed optical interconnects rather than traditional electrical interconnects. An optical interface typically uses a photonic integrated circuit (PIC) to send and receive optical signals over optical channels.

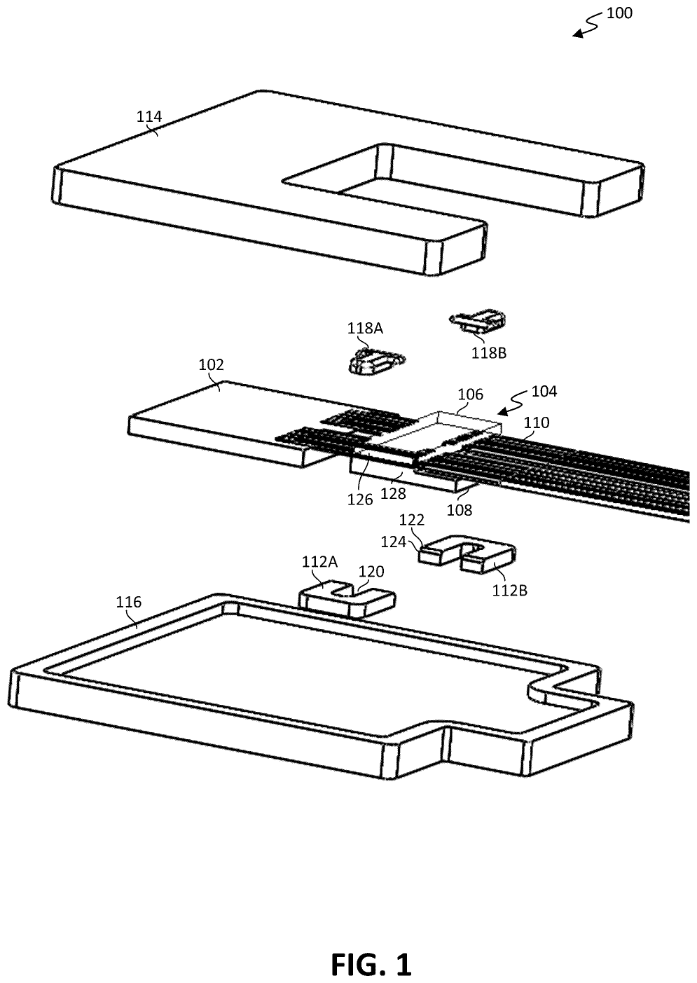

FIG. 1 illustrates an exploded view of a package 100 comprising a photonic integrated circuit and discrete coupling features, in accordance with any of the embodiments disclosed herein. In typical systems, an optical coupling device (e.g., a fiber array unit (FAU) or optical coupler) is secured to a package substrate or integrated heat spreader (IHS) using adhesive. However, there are no self-alignment features or mechanical connections, but the connection relies wholly on the adhesive bond. However, temperature cycling and socketing (e.g., connecting or disconnecting the other end of the optical coupling device) may stress or compromise the connection to the PIC.

In various embodiments of the present disclosure, one or more coupling features (e.g., mechanical couplers) are included to facilitate coupling between the optical coupling device and one or more of a die comprising a PIC, a package substrate, and an IHS. In some examples, a bonding material such as adhesive or solder may be applied to connect the optical coupling device to the one or more coupling features. In various embodiments, the same adhesive or solder may connect the one or more coupling features to the die, package substrate, and/or IHS. In other embodiments, the one or more coupling features may be connected to the die, package substrate, and/or IHS in any other suitable manner. The improved connection strength may result in more flexibility in the mechanical adhesives used (e.g., adhesive materials may be specifically chosen to address concerns such as coefficient of thermal expansion (CTE) related issues or other important characteristics). In some instances, use of a coupling feature provides an indirect mechanical connection of the fibers or coupler of the optical coupling device onto the die through the substrate, thus significantly increasing the coupling area.

Various embodiments of the present disclosure may provide technical advantages, such as one or more of a stronger bond (e.g., including improved shear and/or tensile strength) between an optical coupling device and a PIC, improved alignment of an optical coupling device with a PIC, and alleviation of issues caused by differences in CTE of the optical coupling device and the IHS (e.g., the IHS may have a much higher rate of expansion than the material of the optical coupling device). The one or more coupling features may firmly attach and protect the connection of the optical coupling device to the PIC against the stress of the I/O connection, make it easier to passively align to the PIC and/or preventing thermodynamic effects from disrupting the connection.

The package 100 may include an integrated circuit die 102 comprising a PIC, an optical coupling device 104 (e.g., a fiber array unit), a package substrate 114 to attach to the die 102, coupling features 112 (e.g., 112A and 112B), and an integrated heat spreader 116.

In various embodiments of the present disclosure, any number of coupling features 112 may be used to provide coupling support between an optical coupling device 104 and a PIC die 102. A coupling feature may be attached (e.g., via adhesive, solder, and/or other bonding mechanism) to the optical coupling device 104 and to one or more of the PIC die 102, the package substrate 114, and the IHS 116. In the embodiment depicted, two coupling features 112A and 112B are present.

The coupling features may have any suitable shape. In the embodiment depicted in FIG. 1, the coupling features are generally U-shaped, with a first portion generally parallel with the direction of the optical channels (e.g., fibers 110 or waveguides, not shown) of the optical coupling device 104 and second portions on either end of the first portion that extend generally perpendicular to the first portion. As such, the coupling features 112 each have an open space 120.

In various embodiments, a bonding material 118A, 118B may be placed into the open spaces 120 to bond the coupling features 112 to the optical coupling device 104. As used herein, a bonding material may include any suitable adhesive (e.g., comprising epoxy, silicone, acrylic, or other suitable material), solder, tape, or other suitable bonding mechanism. In various embodiments, the bonding material 118 may contact sides and/or the bottom surface of the optical coupling device 104. In some embodiments, the bonding material may also contact the package substrate 114, thus mechanically connecting the optical coupling device 104 to the substrate 114 and significantly strengthening the mechanical connection between the optical coupling device 104 and the PIC die 102.

In some embodiments, when the bonding material 118 is adhesive, the adhesive may be dispensed and then cured with ultraviolet (UV) light. In other embodiments, when the bonding material 118 is solder, heat or a laser may be applied to perform the bonding.

In other embodiments, a coupling feature 112 may be attached to the substrate 114 in a separate process step (e.g., prior to attachment of the coupling feature to the optical coupling device). For example, the coupling feature 112 may be attached to the substrate 114 with solder, a compliant epoxy (e.g., to allow the coupling feature 112 to float slightly on the substrate as components of the package expand at different rates), tape, or other suitable bonding material. In some embodiments, the coupling feature 112 may be attached to the substrate 114 using the same bonding material used to bond one or more other components (e.g., capacitors, resistors, etc.) to the substrate 114.

In some embodiments, the bonding material 118 may contact the IHS 116. In one example, the bonding material 118 may comprise an adhesive or other material that is able to stretch, such that if the IHS 116 expands at a rate that is greater than a rate of expansion of the optical coupling device 104, then the bonding material 118 may stretch without causing the expansion of the IHS 116 to pull on the optical coupling device 104 and compromise the connection between the optical coupling device 104 and the PIC die 102. In some embodiments, a portion of the optical coupling device 104 may include a material (e.g., glass) that has a CTE that is relatively close to the CTE of a material (e.g., Kovar) of the coupling feature 112, such that the optical coupling device and the coupling feature may expand at similar rates due to temperature increases.

A coupling feature 112 may comprise any suitable material, such as a metal, ceramic, plastic, silicon, or glass. In various embodiments, the coupling feature 112 may predominantly comprise a rigid material, such as those listed above.

In some embodiments, a coupling feature 112 comprises a material having a relatively low CTE. For example, the CTE of the coupling feature 112 may be significantly smaller (e.g., less than ½, less than ⅕, etc.) than the CTE of the IHS. In one example, the CTE of the coupling feature 112 is less than 9×10⁻⁶ (m/m)/° C. (at 20° C.). In another example, the CTE of the coupling feature 112 is less than 3.5×10⁻⁶ (m/m)/° C. (at 20° C.).

The components of the package 100 may be assembled in any suitable order. In various embodiments, the coupling features 112 are attached to the package substrate either before, after, or concurrently with the attachment of the PIC die 102 to the package substrate 114. The optical coupling device is then attached to the die. The bonding material 118 is then applied to bond the coupling features 112 to the optical coupling device. Finally, the IHS is attached to the PIC die 102 and/or package substrate. Other suitable orders of these operations are contemplated by this disclosure.

The package substrate 114 may be any suitable substrate, such as an organic package substrate comprising organic materials such as organic resin or epoxy resin. The package substrate 114 may include any suitable dielectric materials and interconnect materials. Although not shown, in various embodiments, the package substrate 114 may be attached to other suitable integrated circuit components (examples of which will be described in connection with other FIGS. herein).

The package substrate 114 may have any suitable shape. For example, in the embodiment depicted, the top surface of the substrate 114 is generally rectilinear with a generally rectilinear cavity to allow access for attachment of an optical coupling device (e.g., fiber array unit) to the PIC die 102.

The integrated heat spreader (IHS) 116 may be used to provide heat dissipation and/or provide physical protection to the PIC die 102 and/or other integrated circuit components attached to the package substrate 114. In various embodiments, the IHS comprises a material (e.g., a metal) with a high coefficient of thermal expansion (CTE). In one example, the IHS 116 predominantly comprises copper. In some instances, the IHS 116 comprises nickel-plated copper or gold-plated copper. In various embodiments, the IHS may be in physical contact with the PIC die 102. For example, the IHS may be physically attached to the PIC die 102 in any suitable manner.

As described above, a PIC die 102 may be connected to an optical coupling device 104, such as a fiber array unit (FAU) or an optical coupler. When connected, optical channels (e.g., fibers or waveguides) of the PIC die 102 may be aligned with optical channels (e.g., fibers or waveguides) of the optical coupling device 104. For example, the optical coupling device 104 is depicted as an FAU. An FAU may comprise an array of optical fibers 110 to communicate optical signals with corresponding waveguides of the PIC die 102. When an FAU is connected to a PIC die 102, the fibers of the fiber array unit are precisely aligned with the waveguides of the PIC to mitigate insertion loss and enable communication between the PIC and the fiber array unit (and are thus communicatively coupled together). In various embodiments, the PIC die 102 may include grooves (e.g., V-grooves) in line with its waveguides and the fibers 110 are placed within the grooves. In some instances, the fibers 110 may be attached to the PIC die 102 with an adhesive, such as an index-matching epoxy (IME).

The fibers 110 may comprise any material (e.g., silica) suitable to communicate an optical signal. The fibers 110 may be single-mode or multimode fibers. The fibers 110 are disposed between at least one rigid portion, such as an upper block 106 and a lower block 108. While blocks are shown as being generally rectilinear herein, the shapes of the blocks are not limited thereto. The fibers may be aligned between the blocks 106 and 108 with the appropriate spacing between adjacent fibers and proper orientation (e.g., by being placed within grooves of one or both of the blocks and/or being secured to the blocks, e.g., through an adhesive). The fibers may include coating (e.g., an acrylic coating) over a portion of the fibers, while other portions may omit this coating (and thus the bare fiber may be exposed). For example, the portion of the fibers that is encased by the blocks 106 and 108 and the portions that extend out from the blocks may be bare. The fibers 110 may be coupled to the blocks 106 and 108 proximate a first end (where bare fibers 110 extend outward from the blocks) and may be coupled to a connector (e.g., a mechanical transfer (MT) ferrule) at a second end (not shown).

The connector at the second end of the FAU may comprise a multi-fiber connector to align and protect multiple fibers. The connector may comprise a rigid material, e.g., ceramic, metal, plastic, or glass. The connector may enable a connection (e.g., via alignment pin holes) between the fibers 110 and an optical device connected to the connector. The connector may connect to any suitable optical device (e.g., another PIC, a processor, a network interface controller (NIC), a storage, a memory, an I/O device, another integrated circuit, another optical connector, etc.), such as another computing component that is included in the same package or in an external device or system.

Upper block 106 may comprise a rigid material. In one embodiment, upper block 106 comprises glass. In various embodiments, the upper block 106 may be transparent (e.g., to allow for ultraviolet (UV) curing of epoxy adhesive used to connect the upper block 106 to the fibers 110 and/or the lower block 108). Lower block 108 may also comprise a rigid material. In various embodiments, lower block 108 may comprise the same material as the upper block or a different material. In one embodiment, the lower block 108 comprises a metal alloy, such as Kovar (which may or may not be plated with a conductive material, such as gold). In some embodiments, when the lower block 108 comprises metal, it may be attached to a coupling feature 112 via solder.

Although the FIGS. depict assemblies with two sets of twelve fibers that are separated by a portion that does not include fibers, other assemblies consistent with embodiments of the disclosure may include any suitable number of fibers (e.g., eight, ten, twelve, sixteen, twenty, twenty four, etc.) and any suitable number of sets (for example a single set, two sets, four sets, etc.).

In other embodiments, the optical coupling device may comprise an optical coupler. The optical coupler may include waveguides (e.g., formed within one or more glass pieces) to align at a first end with waveguides of the PIC die 102 and at a second end with optical channels (e.g., waveguides or fibers) of another optical device. For example, the second end may interface with a ferrule of the other optical device or waveguides of the other optical device. Other suitable arrangements are contemplated herein for the optical coupler.

Although in the embodiment depicted the sides 126 and 128 of the upper block 106 and lower block 108 are in the same plane, in other embodiments, the sides of the upper block may extend past the corresponding sides of the lower block 108. For example, the sides of the upper block may have ledges that at least partially extend over the open spaces 120 of the coupling features 112, such that the undersides of the ledges as well as the sides of the lower block 108 may be in contact with the bonding material 118 and connected to the coupling features 112.

In some embodiments, a coupling feature 112 may include surfaces 122, 124 with multiple height levels and the bottom surface of the optical coupling device (e.g., the lower surface of lower block 108) may rest on the top of one of the levels (e.g., surface 124). Such an embodiment may assist in aligning the optical coupling device to the correct height.

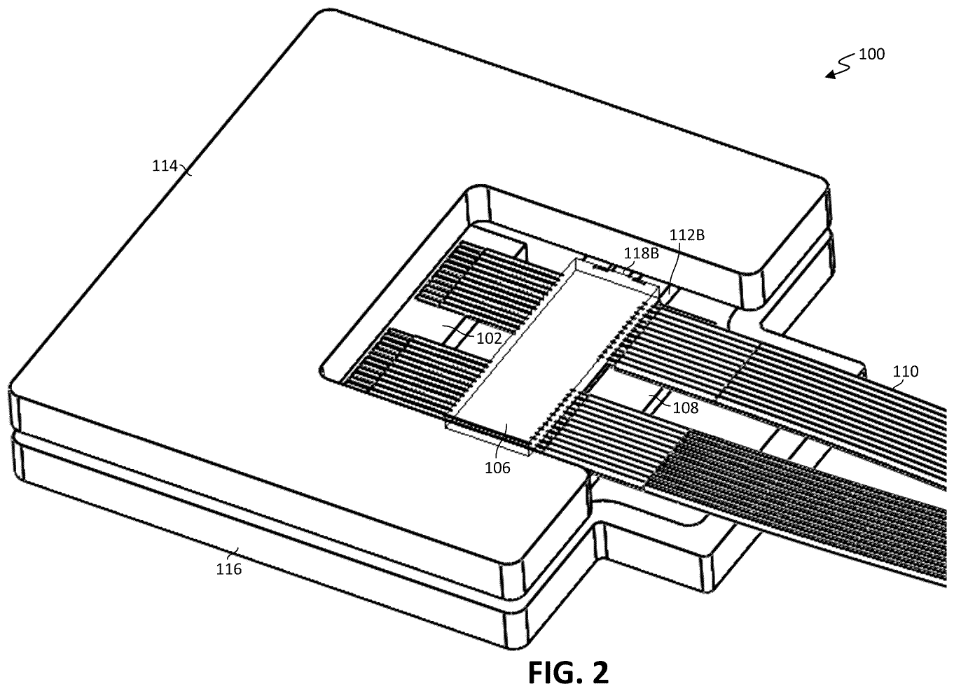

FIG. 2 illustrates the assembled package 100. In this depiction, the PIC die 102 is attached to the package substrate 114. The optical coupling device 104 has been attached to the PIC die 102. The coupling features 112 have been attached to the optical coupling device 104 and the package substrate 114, thus further securing the connection between PIC die 102 and the optical coupling device 104.

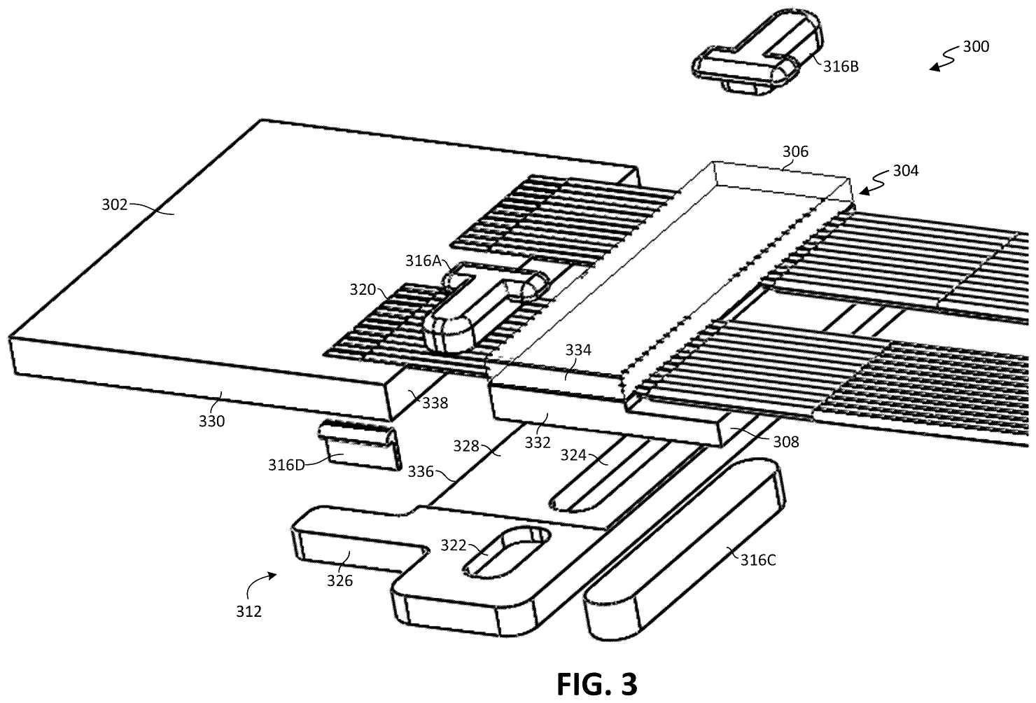

FIG. 3 illustrates an exploded view 300 of a PIC die 302 and a coupling feature 312 having an open cavity 324, in accordance with any of the embodiments disclosed herein. The view also depicts an optical coupling device 304 (e.g., FAU) as well as bonding material 316 (e.g., 316A, 316B, 316C, 316D) that may be used to attach the coupling feature 312 to one or more of the optical coupling device 304, PIC die 302, and an IHS (not shown).

In various embodiments, the coupling feature 312 may be symmetric. Each side of the coupling feature may include a shoulder portion 326 that is to extend around a respective side (e.g., 330) of the PIC die 302. The shoulder portion 326 may be attached to the side of the PIC die 302 through bonding material 316D. The bonding material may contact a side of the shoulder 326 and a corresponding side (e.g., 330) of the PIC die 302. In some instances, the bonding material may also contact a portion of the top surface of the shoulder as well. Although not shown, the other side of the coupling feature 312 may include a similar shoulder portion that is attached to the other side of the PIC die 302 through similar bonding material.

Each shoulder portion 326 may also include a recessed portion 322 into which the bonding material 316A, 316B may be placed. The bonding material 316 may contact the bottom of the recessed portion 322 as well as the sidewalls of the recessed portion. This bonding material 316 may be used to attach the coupling feature 312 to a package substrate and/or to the optical coupling device 304 (e.g., FAU) (e.g., by contacting sides such as 332, 334 of the optical coupling device).

The coupling feature 312 may also include a main portion 328 in between the shoulders 326. In this embodiment, the main portion 328 has a width that is slightly wider than the optical coupling device (e.g., the lower block 308 of optical coupling device 304), such that the optical coupling device may interface (e.g., contact, rest on, be attached to) with the main portion 328 (which may also be referred to as a shelf). In various embodiments, the main portion 328 may have a smaller height than the shoulder portions 326. The front side 336 of the main portion 328 may abut a side 338 of the die or be offset from the side of the die by any suitable length.

The main portion 328 may include an open cavity 324. Bonding material 316C may be placed in the area of the open cavity to bond the bottom surface of the optical coupling device 304 to the coupling feature 312. In some embodiments, the open cavity 324 may be filled with the bonding material prior to placement of the optical coupling device on the main portion 328. In various embodiments, the open cavity 324 may be wider than the optical coupling device (or the open cavity 324 is otherwise exposed when the optical coupling device 304 is placed on the main portion 328), such that a bonding material 316C may be applied to the exposed area and may flow underneath the optical coupling device when the optical coupling device is already resting on the main portion 328. When the bonding material is an adhesive cured by UV light, although the UV light cannot directly expose the adhesive in the cavity, exposed adhesive at the edge of the cavity may start a crosslinking reaction, which will continue across the cavity, securing the optical coupling device to coupling feature 312 (and thus helping secure the PIC to the optical coupling device).

In some instances, because the cavity 324 is open at the bottom, the bonding material 316C may contact an IHS (not shown) and bond the IHS to the coupling feature 312. Similarly, other bonding material (e.g., 316D) could similarly bond the IHS to the coupling feature.

The components of a package comprising the coupling feature 312 may be assembled in any suitable order. For example, if the coupling feature 312 is to be attached to the package substrate and the PIC die 302, the coupling feature may be attached to the substrate (e.g., using any suitable bonding material, such as 316A, 316B) and then to the die (e.g., via bonding material 316D and corresponding bonding material on the other side). In some instances, the attachment of the coupling feature 312 and the PIC die 302 to the substrate may be performed concurrently.

As another example, if the coupling feature 312 is to be attached to the PIC die 302 but not the package substrate, then the coupling feature 312 may be attached to the PIC die 302 by bonding material 316D prior to attachment of the optical coupling device 304. In another example, the substrate, PIC die 302, and IHS may be assembled without the optical coupling device 304, then the coupling feature 312 may be placed such that the shoulders 326 are adjacent to the sides of the PIC die 302 and/or the front side 336 of the coupling feature 312 is adjacent a corresponding side 338 of the PIC die 302 and then bonding material may be applied to attach the coupling feature 312 to the PIC die 302 (in some instances bonding material that is not shown may be applied along at least a portion of the edge between the front side 336 and the top surface of the main portion 328). The optical coupling device 304 may then be attached to the PIC die 302. Other suitable orders of these operations are contemplated by this disclosure.

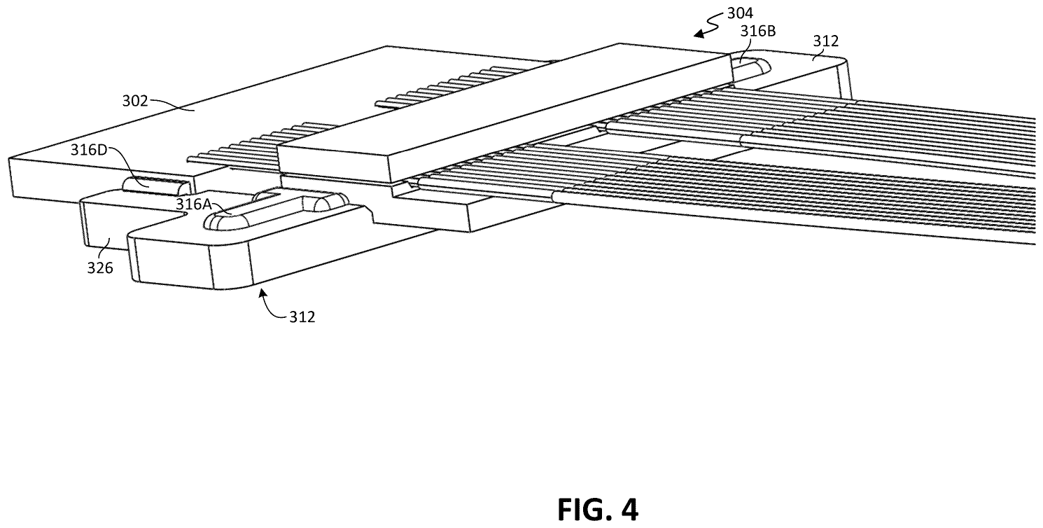

FIG. 4 illustrates the PIC die 302 and coupling feature 312 of FIG. 3, in accordance with any of the embodiments disclosed herein. In this depiction, the PIC die 302 is attached to the coupling feature 312 (e.g., via bonding materials 316D and 316F). The coupling feature 312 is also attached to the optical coupling device 304 (e.g., via bonding material such as 316C underneath the optical coupling device). The optical coupling device 304 is attached to the PIC die 302, such that the optical channels of the optical coupling device 304 align with the waveguides 320 of the PIC die 302.

The bonding materials 316A, 316B may further secure the coupling feature 312 to the optical coupling device 304 and/or to a package substrate (not shown). An IHS (not shown) may also be attached to the PIC die 302, package substrate, and/or coupling feature 312 (e.g., via bonding material 316C, 316D).

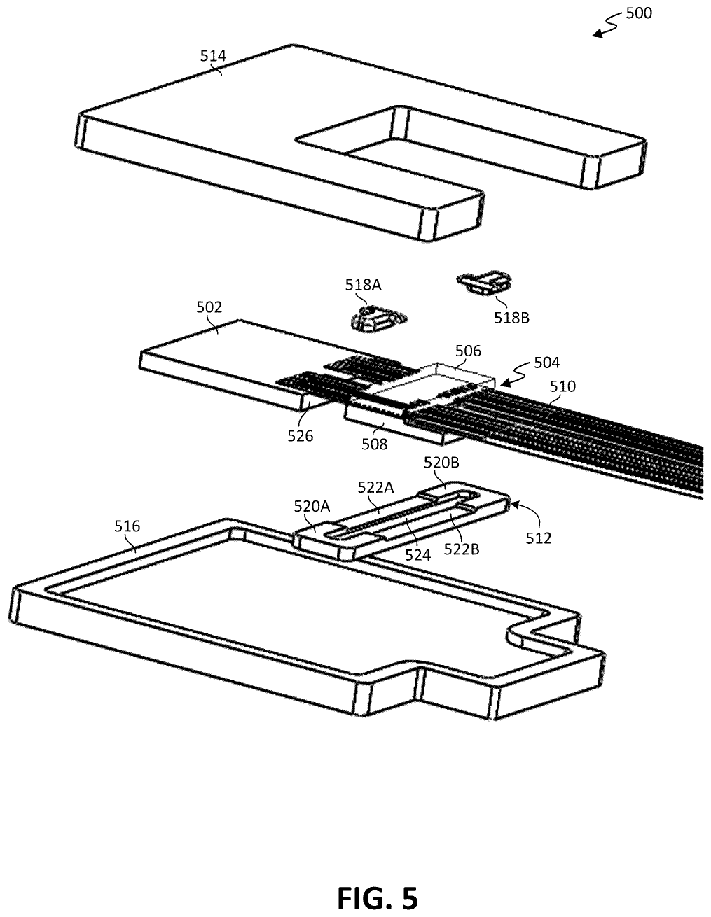

FIG. 5 illustrates a package 500 comprising a PIC die 502 and a coupling feature 512 having a closed cavity, in accordance with any of the embodiments disclosed herein. The package 500 may include an integrated circuit die comprising a PIC die 502, an optical coupling device 504 (e.g., a fiber array unit comprising a top block 506, a bottom block 508, and fibers 510 disposed between the top block and bottom block), a package substrate 514 to attach to the PIC die 502, a coupling feature 512, and an IHS 516.

In this embodiment, the coupling feature 512 includes ends 520A and 520B, ledges 522A and 522B, and a closed cavity 524. The ledges 522 may be recessed (e.g., at a lower height) relative to the ends 520, and the closed cavity 524 may be recessed relative to the ledges 522. When the optical coupling device 504 is attached to the PIC die 502, it may rest on or otherwise interface with the ledges 522A and 522B (optionally with bonding material in between the ledges and the optical coupling device 504), and bonding material (not shown) applied within the closed cavity 524 may contact the optical coupling device 504 to attach it to the coupling feature 512. In various embodiments, the bonding material may contact the sides and/or the bottom surface of the optical coupling device.

The coupling feature 512 may also be attached to the package substrate 514 via any suitable bonding material (e.g., via bonding material placed on the ends 520 and/or within the closed cavity 524 near the ends 520), such as the same bonding material that attaches the optical coupling device 504 and the coupling feature 512 or a different bonding material.

Due to the closed nature of the cavity 524 (e.g., the bottom of the cavity may be solid such that the bonding material does not escape out of the bottom of the cavity), the bonding material in this embodiment does not contact the IHS 516 and thus the IHS 516 is not attached to the coupling feature 512. Such an embodiment may isolate the optical coupling device 504 from movement caused by the thermal expansion of the IHS 516.

In alternative embodiments, the coupling feature 512 may also attach to the PIC die 502 (e.g., the coupling feature 512 could extend around the sides of the die as in FIGS. 3 and 4 or could be close enough to the front side 526 of the die that bonding material may contact the front side 526 as well as the coupling feature 512). In such an instance, the coupling feature 512 could be attached to the PIC die 502 only, or to both the PIC die 502 and the package substrate 514. In some embodiments, the ledge (e.g., 522B) could extend proximate the back side 528 of the optical coupling device 504 and bonding material could contact the back side 528 and the coupling feature 512. In yet another embodiment, the coupling feature 512 may include a lip that rises from the shelf 522b and around the back side 528 of the optical coupling device.

The components of the package 500 may be assembled in any suitable order. In various embodiments, the coupling feature 512 is attached to the package substrate either before, after, or concurrently with the attachment of the PIC die 502 to the package substrate. The optical coupling device 504 may then be attached to the PIC die 502. Bonding material may then be applied into the closed cavity 524 (e.g., through a portion of the cavity near one or more ends 520 that is still exposed after placement of the optical coupling device 504). When the bonding material is an adhesive cured by UV light, although the UV light cannot directly expose all of the adhesive in the cavity 524, exposed adhesive at the edge of the cavity may start a crosslinking reaction, which will continue across the cavity, securing the optical coupling device 504 to the coupling feature 512. The IHS may then be attached to the PIC die 502 and/or package substrate 514. In another embodiment, the IHS may be attached earlier in the process (e.g., before the optical coupling device is attached). Other suitable orders of these operations are contemplated by this disclosure.

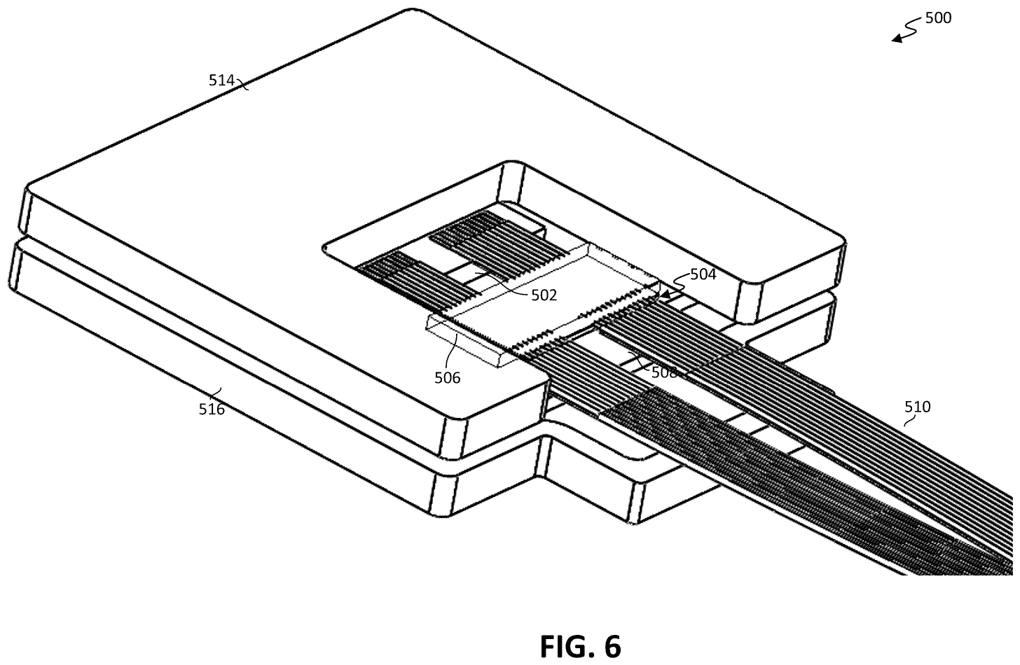

FIG. 6 illustrates the assembled package 500, in accordance with any of the embodiments disclosed herein. In this depiction, the PIC die 502 is attached to the package substrate 514. The optical coupling device 504 has been attached to the PIC die 502. The coupling feature 512 (not visible as it is underneath the optical coupling device 504) has been attached to the optical coupling device 504 and the package substrate 514, thus further securing the connection between PIC die 502 and the optical coupling device 504.

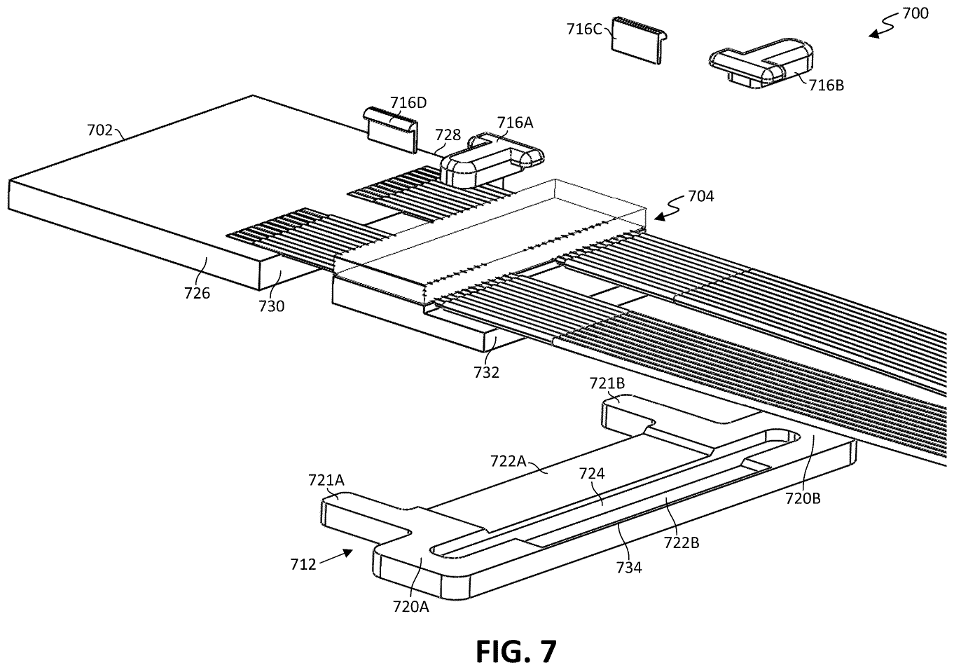

FIG. 7 illustrates an exploded view 700 of a PIC die 702 and a coupling feature 712 with a closed cavity 718, in accordance with any of the embodiments disclosed herein. The view 700 also shows an optical coupling device 704 as well as various bonding materials 716 (e.g., 716A-D).

In this embodiment, the coupling feature 712 includes ends 720A and 720B, shoulders 721A and 721B, shelves 722A and 722B, and a closed cavity 724. The shelves 722 may be recessed (e.g., at a lower height) relative to the ends 720, and the bottom of the closed cavity 724 may be recessed relative to the shelves 722.

When the optical coupling device 704 is attached to the PIC die 702, it may rest on the shelfs 722A and 722B (optionally with bonding material in between the ledges and the optical coupling device 704), and bonding material applied within the closed cavity 724 may contact the optical coupling device 704 to attach it to the coupling feature 712. Such bonding material is not shown in the FIG. In various embodiments, the bonding material may contact the sides and/or the bottom surface of the optical coupling device.

The coupling feature 712 may also be attached to a package substrate via any suitable bonding material (e.g., via bonding material placed on the ends 720 and/or within the closed cavity 724 near the ends 720), such as the same bonding material that attaches the optical coupling device 704 to the coupling feature 712 or a different bonding material.

Due to the closed nature of the cavity 724 (e.g., the bottom of the cavity may be solid such that the bonding material does not escape out of the bottom of the cavity), the bonding material in this embodiment does not contact an IHS (not shown) and thus the IHS is not attached to the coupling feature 712. Such an embodiment may isolate the optical coupling device 704 from movement caused by the thermal expansion of the IHS.

The coupling feature 712 may also attach to the die 702 (e.g., the coupling feature 712 comprises shoulders 721A and 721B that extend around the sides 726 and 728 of the die. The shoulders 721 of the coupling feature 712 may be attached to the PIC die 702 through bonding materials 716C and 716D, which may contact the sides 726 of the PIC die 702 as well as the sides and/or top surface of the shoulders 721.

In the embodiment depicted, the shelf 722A is longer than the shelf 722B. The shelf 722A extends to proximate the front side 730 of the PIC die 702. The shelf 722A may be close enough to the front side 730 of the PIC die 702 that bonding material may contact the front side 730 as well as the shelf 722A of the coupling feature 712). In some embodiments, the coupling feature may be attached to the PIC die 702 only or to both the PIC die 702 and a package substrate (not shown).

The shelf 722b may extend proximate the back side 732 of the optical coupling device 704 and bonding material could contact the back side 732 and the coupling feature 712. The coupling feature 712 may include a lip 734 that rises from the shelf 722b and around the back side 732 of the optical coupling device 704.

The components may be assembled in any suitable order. In various embodiments, the coupling feature 712 is attached to the package substrate and/or PIC die 702 either before, after, or concurrently with the attachment of the PIC die 702 to the package substrate. The optical coupling device 704 may then be attached to the PIC die 702. Bonding material may then be applied into the closed cavity 724 (e.g., through a portion of the cavity near one or more ends 720 that is still exposed after placement of the optical coupling device 704). When the bonding material is an adhesive cured by UV light, although the UV light cannot directly expose all of the adhesive in the cavity 724, exposed adhesive at the edge of the cavity may start a crosslinking reaction, which will continue across the cavity, securing the optical coupling device 704 to the coupling feature 712. An IHS may then be attached to the PIC die 702 and/or package substrate 714. In another embodiment, the IHS may be attached earlier in the process (e.g., before the optical coupling device 704 is attached). Other suitable orders of these operations are contemplated by this disclosure.

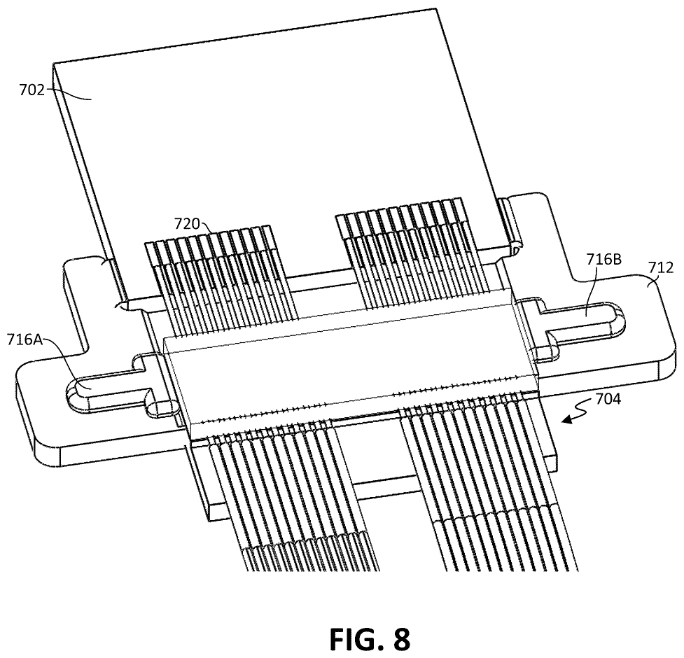

FIG. 8 illustrates the PIC die 702 and coupling feature 712 of FIG. 7, in accordance with any of the embodiments disclosed herein. In this depiction, the PIC die 702 is attached to the optical coupling device 704. The coupling feature 712 has been attached to the optical coupling device 704 and to the PIC die 702. In various embodiments, the coupling feature 712 may be attached to a package substrate as well (e.g., via bonding materials 716A and 716B or via other suitable bonding method).

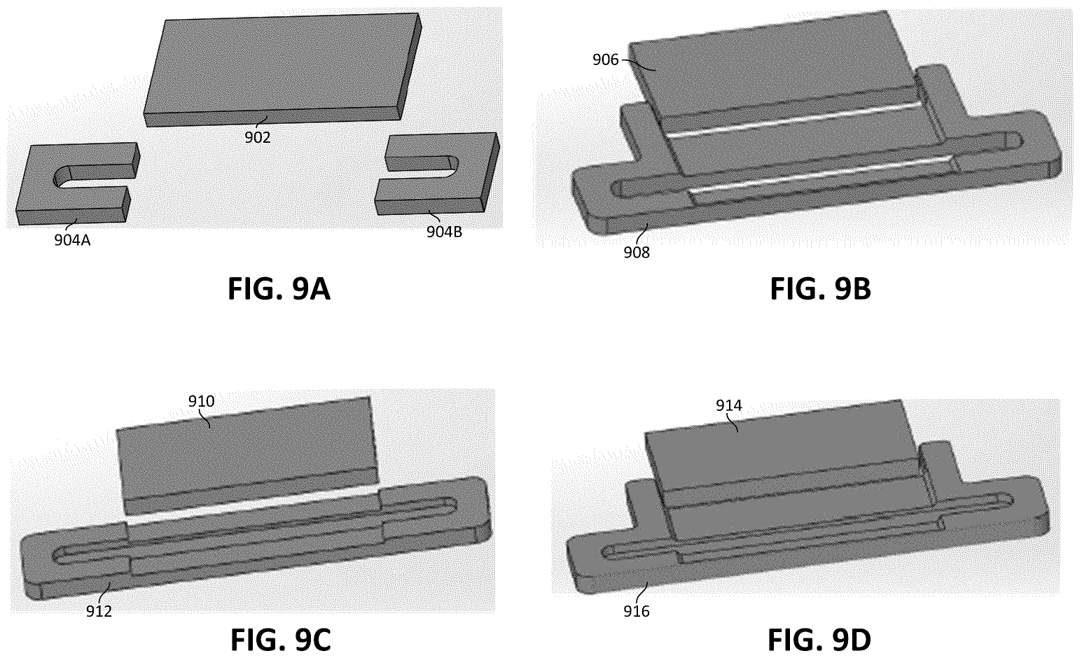

FIGS. 9A-9D illustrate various coupling features and PICs, in accordance with any of the embodiments disclosed herein. The coupling features shown may correspond to (or be variations of) the coupling features depicted in the previous FIGS. The various PICS 902, 906, 910, and 914 are shown to illustrate example scaling and alignment of the coupling features.

For example, coupling features 904A correspond to coupling features 112A and 112B. However, coupling features 904A and 904B have upper surfaces that are at the same level, whereas coupling features 112A and 112B include a top surface 124 at a first level and a top surface 122 at a second level, higher than the first level.

As another example, coupling feature 908 corresponds to coupling feature 312 with slight variations. For example, recessed portion 322 is not present in coupling feature 908 and the open cavity of coupling feature 908 is wider (e.g., it may extend past the extensions on the sides).

In further examples, coupling feature 912 corresponds to coupling feature 512 and coupling feature 916 corresponds to coupling feature 712, although coupling feature 916 does not include lip 734.

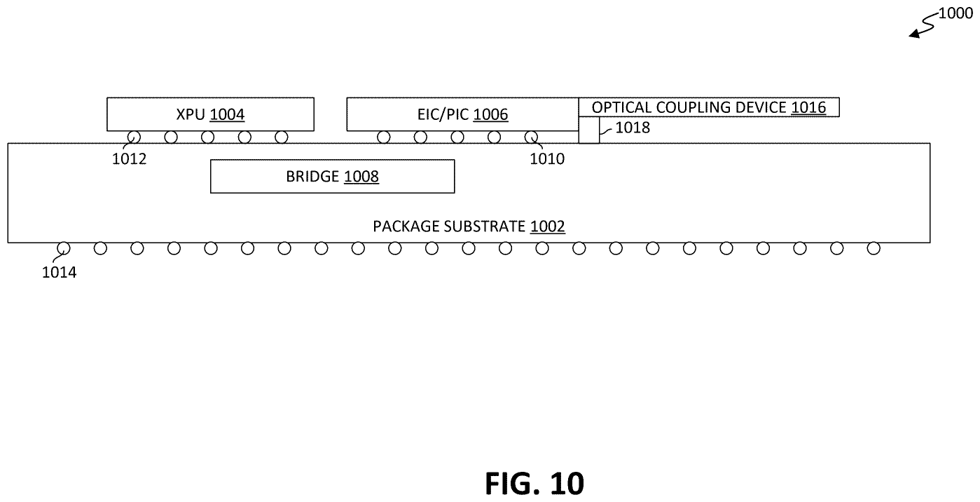

FIG. 10 illustrates an example embodiment of an optical package 1000 in accordance with certain embodiments. In various embodiments, optical package 1000 may include a PIC die (e.g., 1006), an optical coupling device (e.g., 1016), and at least one coupling feature (e.g., 1018) as described throughout this disclosure.

In the illustrated embodiment, the optical package 1000 includes an XPU 1004, an integrated electronic integrated circuit (EIC) and PIC 1006, an optical coupling device 1016, and a coupling feature 1018. The optical coupling device 1016 is attached to the side/edge of the EIC/PIC 1006. In other embodiments, the EIC and the PIC may be on separate dies.

An EIC is used to control a PIC and may include components such as drivers, transimpedance amplifiers (TIA), carrier phase recovery (CPR), clock/data recovery (CDR), serializer/deserializer, equalizer, sampler, and so forth.

The EIC/PIC 1006 is electrically coupled to the package substrate 1002 via conductive contacts 1010 (e.g., bumps/micro-bumps), and the EIC/PIC 1006 is further electrically coupled to the XPU 1004 via bridge 1008 embedded in the package substrate 1002.

A PIC, sometimes referred to as an integrated optical circuit, is an integrated circuit device that incorporates photonic components to create a functional circuit. For example, a PIC may be capable of detecting, generating, transporting, and/or processing light. Unlike electronic integrated circuits (EICs) that rely on electrons, PICs may utilize particles of light called photons. A PIC may enable the manipulation of information signals carried by optical wavelengths, typically within the visible spectrum or near infrared range.

A PIC may be used to send and/or receive optical signals via optical channels (e.g., a medium through which optical signals are transmitted). For example, the PIC of EIC/PIC 1006 may be used to send and/or receive optical signals via optical channels of optical coupling device 1016. In various embodiments, a PIC may send and/or receive optical signals on behalf of another component (e.g., of the same package), such as a processing unit (e.g., an XPU 1004 as described below), network interface controller (NIC), storage, memory, I/O device, or other integrated circuit.

A PIC may include components and circuitry for sending and receiving optical signals, such as one or more electromagnetic radiation sources (e.g., laser diodes (LD)/modulators (LD-MOD), oscillators, light emitting diodes (LEDs), etc.), e.g., for transmitting optical signals; photodiodes (PD), e.g., for receiving optical signals; other optical elements (e.g., polarizers, phase shifters, filters, multiplexers, attenuators, waveguides, optical couplers, collimation/refocusing lenses, reflection mirrors, or amplifiers); active elements (e.g., transistors); passive elements (e.g., resistors, capacitors, or inductors); or other suitable components. In various embodiments, the components of the PIC may be fabricated using any suitable methods, such as semiconductor photolithographic and deposition methods.

A PIC may be controlled by an associated EIC which may be electrically coupled to the PIC. For example, a PIC may be electrically coupled to a surface of an EIC via conductive contacts (e.g., bumps/micro-bumps) of the PIC when the PIC and the EIC are on separate dies.

A PIC may also include an interface for coupling to optical channels of the optical coupling device 1016. The interface may comprise any suitable structure for coupling optical channels of the PIC to optical channels (e.g., fibers) of the optical coupling device 1016. In some embodiments, the interface may include mating and/or alignment features to facilitate mating with the requisite degree of alignment to cause waveguides in a PIC to be precisely aligned with fibers of the optical coupling device.

A waveguide may guide optical signals. A waveguide may also perform any of coupling, switching, splitting, multiplexing, or demultiplexing optical signals. In some instances, a waveguide may include any component configured to feed, or launch, an electromagnetic signal into a medium of propagation such as an optical fiber. A waveguide may be formed in any suitable manner, such as by lithography or laser scribing. In some embodiments, a technique known as direct laser writing (DLW) may be used to generate waveguides with three dimensional (3D) structures (e.g., within a glass substrate). In some embodiments, the waveguides in a PIC are aligned along an optical axis of the PIC.

The optical coupling device 1016 may be used to optically couple, or route optical signals (e.g., light) between, the PIC and another component (e.g., coupled to a ferrule or other connector of the optical coupling device 1016), such as other computing components that are part of the same device or system as optical package 1000 (e.g., processors, XPUs, network interface controllers (NICs), storage, memory, I/O devices, other integrated circuits), an external device or system, a switch, another optical connector, a fiber cable, and so forth.

The XPU 1004 is attached to the top surface of the package substrate 1002. Moreover, the XPU 1004 is electrically coupled to the package substrate 1002 via conductive contacts 1012 (e.g., bumps/micro-bumps), which serve as the first level interconnect (FLI) for the XPU 1004. The XPU 1004 is also electrically coupled to the EIC/PIC 1006 via bridge 1008 embedded in the package substrate 1002 (e.g., embedded multi-die interconnect bridges (EMIB)). In this manner, the XPU 1004 can use the PIC of the EIC/PIC 1006 to communicate over the optical coupling device 1016.

The XPU 1004 may include any type or combination of integrated circuitry that uses the optical coupling device 1016 for optical communication. For example, the XPU 1004 may include any type or combination of processing units or other computing components, including, but not limited to, microcontrollers, microprocessors, processor cores, central processing units (CPUs), graphics processing units (GPUs), vision processing units (VPUs), tensor processing units (TPUs), application-specific integrated circuits (ASICs), field-programmable gate arrays (FPGAs), input/output (I/O) controllers and devices, switches, network interface controllers (NICs), persistent storage devices, and memory.

The package substrate 1002 includes conductive contacts 1014 (e.g., balls, pads) on the bottom surface, which serve as the second level interconnect (SLI) to a next-level component, such as a printed circuit board (e.g., a motherboard) and/or another integrated circuit package (not shown). The package substrate 1002 also includes conductive traces (not shown) patterned in the substrate to provide power and input/output (I/O) to the respective components in package 1000 (e.g., XPU 1004, EIC/PIC 1006).

In some embodiments, the optical package 1000 may be part of an electronic device or system, such as a mobile device, a wearable device, a computer, a server, a video playback device, a video game console, a display device, a camera, or an appliance. For example, the optical package 1000 and various other electronic components may be electrically coupled to a circuit board within the electronic device.

It should be appreciated that optical package 1000 is merely presented as an example. In other embodiments, certain components may be omitted, added, rearranged, modified, or combined. For example, embodiments may include any number, combination, or arrangement of PICs and EICs (e.g., for higher bandwidth and/or redundancy), optical coupler assemblies, fibers, bridges, XPUs or other computing components, substrates, surface cavities in the substrate, conductive contacts, conductive traces, vias, integrated circuit packages, and so forth.

In the embodiment depicted, the coupling feature 1018 is shown as attached to both the EIC/PIC 1006 and the package substrate 1002, while in other embodiments it may only be attached to one of these. The coupling feature 1018 is also attached to the optical coupling device 1016. Although not shown, the optical package 1000 may also include an IHS that is attached to one or more of the XPU 1004, EIC/PIC 1006, and coupling feature 1018.

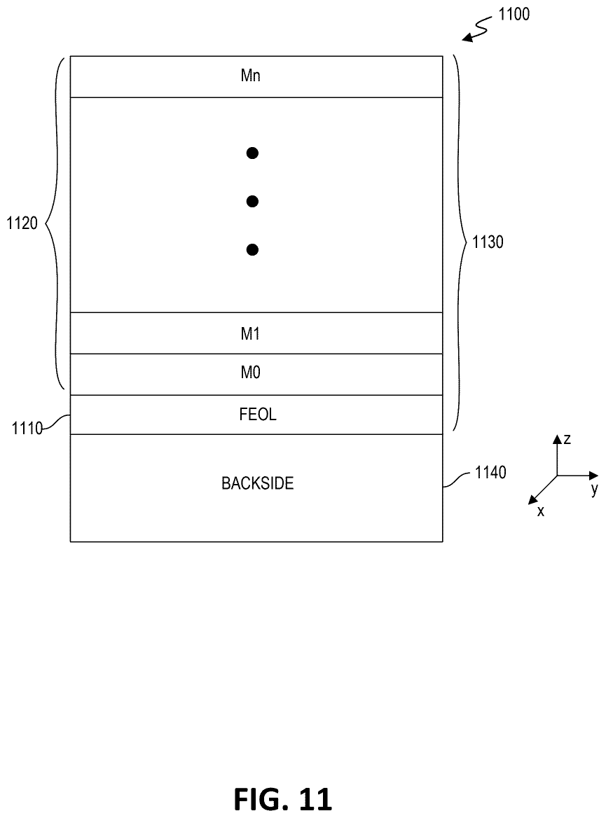

FIG. 11 provides a schematic illustration of a cross-sectional view of an example integrated circuit device (e.g., a die) 1100. The IC device 1100 may include transistors as well as other circuit elements (e.g., resistors, diodes, capacitors, inductors, etc.). In some instances, the IC device 1100 may comprise a PIC, EIC, XPU, or other component described herein.

As shown in FIG. 11, the IC device 1100 may include a front side 1130 comprising a front-end-of-line (FEOL) 1110 that includes various logic layers, circuits, and devices to drive and control a logic IC. These circuits and devices may be configured for any number of functions, such as logic or compute transistors, input/output (I/O) transistors, access or switching transistors, and/or radio frequency (RF) transistors, to name a few examples. According to some embodiments, in addition to these devices and circuits, FEOL 1110 may include, for example, one or more other layers or structures associated with the semiconductor devices and circuits. For example, the FEOL can also include a substrate and one or more dielectric layers that surround active and/or conductive portions of the devices and circuits. The FEOL may also include one or more conductive contacts that provide electrical contact to transistor elements such as gate structures, drain regions, or source regions. The FEOL may also include local interconnect (e.g., vias or lines) that connect contacts to interconnect features within a back-end-of-line (BEOL) 1120.

The front side 1130 of the IC device 1100 also includes a BEOL 1120 including various metal interconnect layers (e.g., metal 0 through metal n, where n is any suitable integer). Various metal layers of the BEOL 1120 may be used to interconnect the various inputs and outputs of the FEOL 1110.

Generally speaking, each of the metal layers of the BEOL 1120, e.g., each of the layers M0-Mn shown in FIG. 11, may include a via portion and a trench/interconnect portion. Typically, the trench portion of a metal layer is above the via portion, but, in other embodiments, a trench portion may be provided below a via portion of any given metal layer of the BEOL 1120. The trench portion of a metal layer may be configured for transferring signals and power along metal lines (also sometimes referred to as “trenches”) extending in the x-y plane (e.g., in the x or y directions), while the via portion of a metal layer may be configured for transferring signals and power through metal vias extending in the z-direction, e.g., to any of the adjacent metal layers above or below. Accordingly, vias connect metal structures (e.g., metal lines or vias) from one metal layer to metal structures of an adjacent metal layer. While referred to as “metal” layers, various layers of the BEOL 1120, e.g., layers MO-Mn shown in FIG. 11, may include certain patterns of conductive metals, e.g., copper (Cu) or aluminum (Al), or metal alloys, or more generally, patterns of an electrically conductive material (e.g., including carbon based materials), formed in an insulating medium such as an interlayer dielectric (ILD). The insulating medium may include any suitable ILD materials such as silicon oxide, silicon nitride, aluminum oxide, and/or silicon oxynitride. In various embodiments, any one or more of these layers may additionally include active devices (e.g., transistors, diodes) and/or passive devices (e.g., capacitors, resistors, inductors).

The IC device 1100 may also include a backside 1140. For example, the backside 1140 may formed on the opposite side of a wafer from the front side 1130. In various embodiments, the backside 1140 may include any suitable elements to assist operation of the IC device 1100. For example, the backside 1140 may include various metal layers to deliver power to logic of the FEOL 1110.

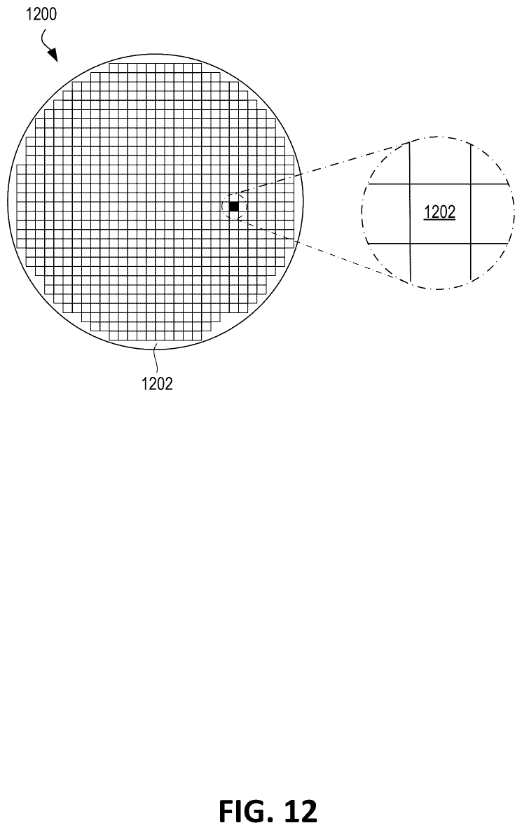

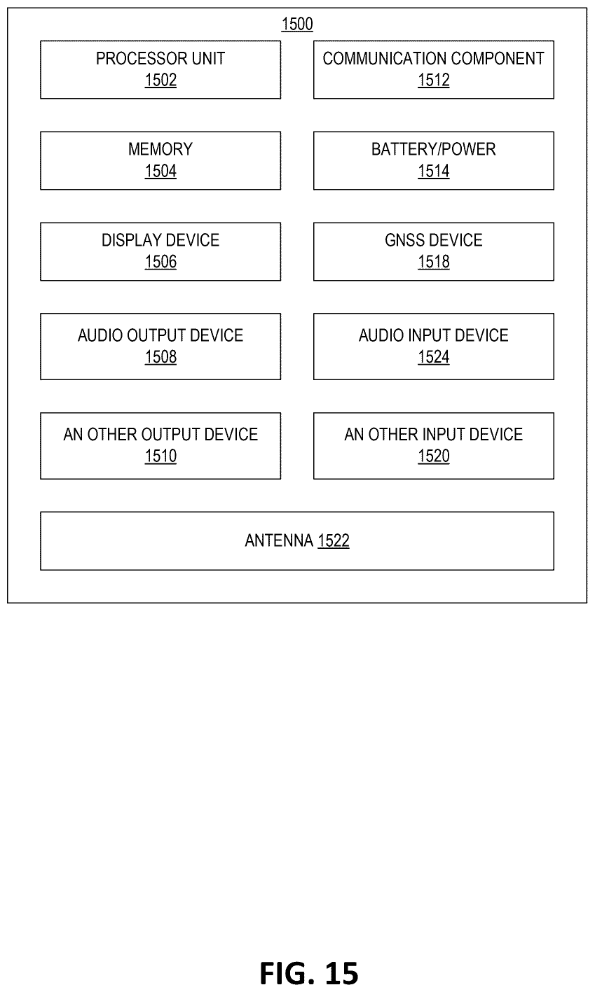

FIG. 12 is a top view of a wafer 1200 and dies 1202, wherein individual dies may include PICs, EICs, XPUs, and/or other components as disclosed herein. The wafer 1200 may be composed of semiconductor material and may include one or more dies 1202 having integrated circuit structures formed on a surface of the wafer 1200. The individual dies 1202 may be a repeating unit of an integrated circuit product that includes any suitable integrated circuit. After the fabrication of the semiconductor product is complete, the wafer 1200 may undergo a singulation process in which the dies 1202 are separated from one another to provide discrete “chips” of the integrated circuit product. The die 1202 may include one or more transistors, supporting circuitry to route electrical signals to the transistors, passive components (e.g., signal traces, resistors, capacitors, or inductors), and/or any other integrated circuit components. In some embodiments, the wafer 1200 or the die 1202 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Multiple ones of these devices may be combined on a single die 1202. For example, a memory array formed by multiple memory devices may be formed on a same die 1202 as a processor unit (e.g., the processor unit 1502 of FIG. 15) or other logic that is configured to store information in the memory devices or execute instructions stored in the memory array. In some embodiments, various ones of the microelectronic assemblies disclosed herein may be manufactured using a die-to-wafer assembly technique in which some dies are attached to a wafer 1200 that include other dies, and the wafer 1200 is subsequently singulated.

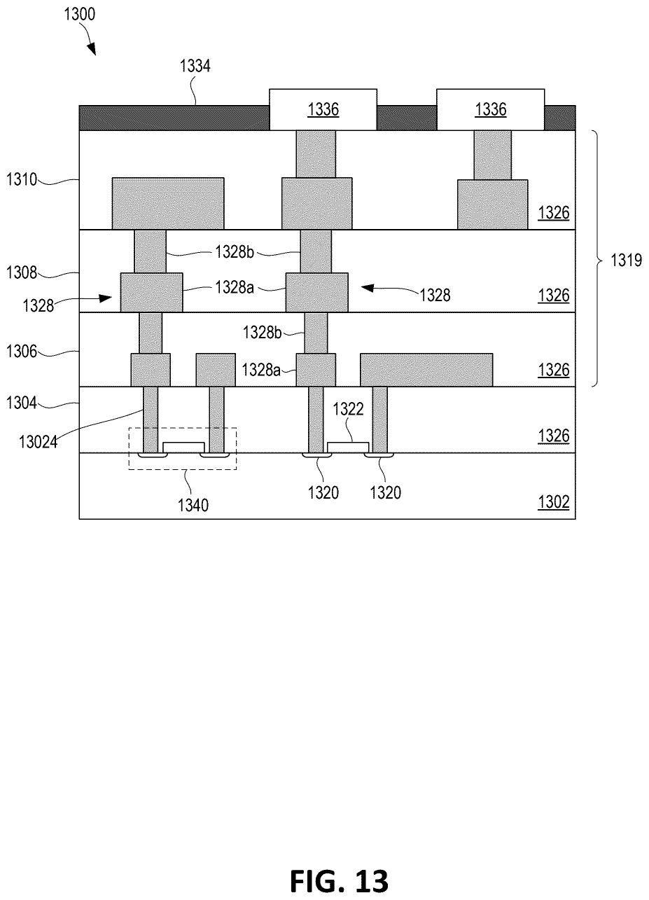

FIG. 13 is a cross-sectional side view of an integrated circuit device 1300 that may include PICs, EICs, XPUs, and/or other components as disclosed herein. One or more of the integrated circuit devices 1300 may be included in one or more dies 1202 (FIG. 12). The integrated circuit device 1300 may be formed on a die substrate 1302 (e.g., the wafer 1200 of FIG. 12) and may be included in a die (e.g., the die 1202 of FIG. 12). The die substrate 1302 may be a semiconductor substrate composed of semiconductor material systems including, for example, n-type or p-type materials systems (or a combination of both). The die substrate 1302 may include, for example, a crystalline substrate formed using a bulk silicon or a silicon-on-insulator (SOI) substructure. In some embodiments, the die substrate 1302 may be formed using alternative materials, which may or may not be combined with silicon, that include, but are not limited to, germanium, indium antimonide, lead telluride, indium arsenide, indium phosphide, gallium arsenide, or gallium antimonide. Further materials classified as group II-VI, III-V, or IV may also be used to form the die substrate 1302. Although a few examples of materials from which the die substrate 1302 may be formed are described here, any material that may serve as a foundation for an integrated circuit device 1300 may be used. The die substrate 1302 may be part of a singulated die (e.g., the dies 1202 of FIG. 12) or a wafer (e.g., the wafer 1200 of FIG. 12).

The integrated circuit device 1300 may include one or more device layers 1304 disposed on the die substrate 1302. The device layer 1304 may include features of one or more transistors 1340 (e.g., metal oxide semiconductor field-effect transistors (MOSFETs)) formed on the die substrate 1302. The transistors 1340 may include, for example, one or more source and/or drain (S/D) regions 1320, a gate 1322 to control current flow between the S/D regions 1320, and one or more S/D contacts 1324 to route electrical signals to/from the S/D regions 1320. The transistors 1340 may include additional features not depicted for the sake of clarity, such as device isolation regions, gate contacts, and the like. The transistors 1340 are not limited to the type and configuration depicted in FIG. 13 and may include a wide variety of other types and configurations such as, for example, planar transistors, non-planar transistors, or a combination of both. Non-planar transistors may include FinFET transistors, such as double-gate transistors or tri-gate transistors, and wrap-around or all-around gate transistors, such as nanoribbon, nanosheet, or nanowire transistors.

A transistor 1340 may include a gate 1322 formed of at least two layers, a gate dielectric and a gate electrode. The gate dielectric may include one layer or a stack of layers. The one or more layers may include silicon oxide, silicon dioxide, silicon carbide, and/or a high-k dielectric material.

The high-k dielectric material may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be carried out on the gate dielectric to improve its quality when a high-k material is used.

The gate electrode may be formed on the gate dielectric and may include at least one p-type work function metal or n-type work function metal, depending on whether the transistor 1340 is to be a p-type metal oxide semiconductor (PMOS) or an n-type metal oxide semiconductor (NMOS) transistor. In some implementations, the gate electrode may consist of or comprise a stack of two or more metal layers, where one or more metal layers are work function metal layers and at least one metal layer is a fill metal layer. Further metal layers may be included for other purposes, such as a barrier layer.

For a PMOS transistor, metals that may be used for the gate electrode include, but are not limited to, ruthenium, palladium, platinum, cobalt, nickel, conductive metal oxides (e.g., ruthenium oxide), and any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and aluminum carbide), and any of the metals discussed above with reference to a PMOS transistor (e.g., for work function tuning).

In some embodiments, when viewed as a cross-section of the transistor 1340 along the source-channel-drain direction, the gate electrode may consist of or comprise a U-shaped structure that includes a bottom portion substantially parallel to the surface of the die substrate 1302 and two sidewall portions that are substantially perpendicular to the top surface of the die substrate 1302. In other embodiments, at least one of the metal layers that form the gate electrode may simply be a planar layer that is substantially parallel to the top surface of the die substrate 1302 and does not include sidewall portions substantially perpendicular to the top surface of the die substrate 1302. In other embodiments, the gate electrode may consist of or comprise a combination of U-shaped structures and planar, non-U-shaped structures. For example, the gate electrode may consist of one or more U-shaped metal layers formed atop one or more planar, non-U-shaped layers.

In some embodiments, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and silicon oxynitride. Processes for forming sidewall spacers are well known in the art and generally include deposition and etching process steps. In some embodiments, a plurality of spacer pairs may be used; for instance, two pairs, three pairs, or four pairs of sidewall spacers may be formed on opposing sides of the gate stack.

The S/D regions 1320 may be formed within the die substrate 1302 adjacent to the gate 1322 of individual transistors 1340. The S/D regions 1320 may be formed using an implantation/diffusion process or an etching/deposition process, for example. In the former process, dopants such as boron, aluminum, antimony, phosphorous, or arsenic may be ion-implanted into the die substrate 1302 to form the S/D regions 1320. An annealing process that activates the dopants and causes them to diffuse farther into the die substrate 1302 may follow the ion-implantation process. In the latter process, the die substrate 1302 may first be etched to form recesses at the locations of the S/D regions 1320. An epitaxial deposition process may then be carried out to fill the recesses with material that is used to fabricate the S/D regions 1320. In some implementations, the S/D regions 1320 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 1320 may be formed using one or more alternate semiconductor materials such as germanium or a group III-V material or alloy. In further embodiments, one or more layers of metal and/or metal alloys may be used to form the S/D regions 1320.

Electrical signals, such as power and/or input/output (I/O) signals, may be routed to and/or from the devices (e.g., transistors 1340) of the device layer 1304 through one or more interconnect layers disposed on the device layer 1304 (illustrated in FIG. 13 as interconnect layers 1306-1310). For example, electrically conductive features of the device layer 1304 (e.g., the gate 1322 and the S/D contacts 1324) may be electrically coupled with the interconnect structures 1328 of the interconnect layers 1306-1310. The one or more interconnect layers 1306-1310 may form a metallization stack (also referred to as an “ILD stack”) 1319 of the integrated circuit device 1300.

The interconnect structures 1328 (e.g., lines) may be arranged within the interconnect layers 1306-1310 to route electrical signals according to a wide variety of designs; in particular, the arrangement is not limited to the particular configuration of interconnect structures 1328 depicted in FIG. 13. Although a particular number of interconnect layers 1306-1310 is depicted in FIG. 13, embodiments of the present disclosure include integrated circuit devices having more or fewer interconnect layers than depicted.

In some embodiments, the interconnect structures 1328 may include lines 1328a and/or vias 1328b filled with an electrically conductive material such as a metal. The lines 1328a may be arranged to route electrical signals in a direction of a plane that is substantially parallel with a surface of the die substrate 1302 upon which the device layer 1304 is formed. For example, the lines 1328a may route electrical signals in a direction in and out of the page and/or in a direction across the page. The vias 1328b may be arranged to route electrical signals in a direction of a plane that is substantially perpendicular to the surface of the die substrate 1302 upon which the device layer 1304 is formed. In some embodiments, the vias 1328b may electrically couple lines 1328a of different interconnect layers 1306-1310 together.

The interconnect layers 1306-1310 may include a dielectric material 1326 disposed between the interconnect structures 1328, as shown in FIG. 13. In some embodiments, dielectric material 1326 disposed between the interconnect structures 1328 in different ones of the interconnect layers 1306-1310 may have different compositions; in other embodiments, the composition of the dielectric material 1326 between different interconnect layers 1306-1310 may be the same. The device layer 1304 may include a dielectric material 1326 disposed between the transistors 1340 and a bottom layer of the metallization stack as well. The dielectric material 1326 included in the device layer 1304 may have a different composition than the dielectric material 1326 included in the interconnect layers 1306-1310; in other embodiments, the composition of the dielectric material 1326 in the device layer 1304 may be the same as a dielectric material 1326 included in any one of the interconnect layers 1306-1310.

A first interconnect layer 1306 (referred to as Metal 1 or “M1”) may be formed directly on the device layer 1304. In some embodiments, the first interconnect layer 1306 may include lines 1328a and/or vias 1328b, as shown. The lines 1328a of the first interconnect layer 1306 may be coupled with contacts (e.g., the S/D contacts 1324) of the device layer 1304. The vias 1328b of the first interconnect layer 1306 may be coupled with the lines 1328a of a second interconnect layer 1308.

The second interconnect layer 1308 (referred to as Metal 2 or “M2”) may be formed directly on the first interconnect layer 1306. In some embodiments, the second interconnect layer 1308 may include via 1328b to couple the lines 1328 of the second interconnect layer 1308 with the lines 1328a of a third interconnect layer 1310. Although the lines 1328a and the vias 1328b are structurally delineated with a line within individual interconnect layers for the sake of clarity, the lines 1328a and the vias 1328b may be structurally and/or materially contiguous (e.g., simultaneously filled during a dual-damascene process) in some embodiments.

The third interconnect layer 1310 (referred to as Metal 3 or “M3”) (and additional interconnect layers, as desired) may be formed in succession on the second interconnect layer 1308 according to similar techniques and configurations described in connection with the second interconnect layer 1308 or the first interconnect layer 1306. In some embodiments, the interconnect layers that are “higher up” in the metallization stack 1319 in the integrated circuit device 1300 (i.e., farther away from the device layer 1304) may be thicker that the interconnect layers that are lower in the metallization stack 1319, with lines 1328a and vias 1328b in the higher interconnect layers being thicker than those in the lower interconnect layers.

The integrated circuit device 1300 may include a solder resist material 1334 (e.g., polyimide or similar material) and one or more conductive contacts 1336 formed on the interconnect layers 1306-1310. In FIG. 13, the conductive contacts 1336 are illustrated as taking the form of bond pads. The conductive contacts 1336 may be electrically coupled with the interconnect structures 1328 and configured to route the electrical signals of the transistor(s) 1340 to external devices. For example, solder bonds may be formed on the one or more conductive contacts 1336 to mechanically and/or electrically couple an integrated circuit die including the integrated circuit device 1300 with another component (e.g., a printed circuit board). The integrated circuit device 1300 may include additional or alternate structures to route the electrical signals from the interconnect layers 1306-1310; for example, the conductive contacts 1336 may include other analogous features (e.g., posts) that route the electrical signals to external components.

In some embodiments in which the integrated circuit device 1300 is a double-sided die, the integrated circuit device 1300 may include another metallization stack (not shown) on the opposite side of the device layer(s) 1304. This metallization stack may include multiple interconnect layers as discussed above with reference to the interconnect layers 1306-1310, to provide conductive pathways (e.g., including conductive lines and vias) between the device layer(s) 1304 and additional conductive contacts (not shown) on the opposite side of the integrated circuit device 1300 from the conductive contacts 1336.

In other embodiments in which the integrated circuit device 1300 is a double-sided die, the integrated circuit device 1300 may include one or more through silicon vias (TSVs) through the die substrate 1302; these TSVs may make contact with the device layer(s) 1304, and may provide conductive pathways between the device layer(s) 1304 and additional conductive contacts (not shown) on the opposite side of the integrated circuit device 1300 from the conductive contacts 1336. In some embodiments, TSVs extending through the substrate can be used for routing power and ground signals from conductive contacts on the opposite side of the integrated circuit device 1300 from the conductive contacts 1336 to the transistors 1340 and any other components integrated into the integrated circuit device (e.g., die) 1300, and the metallization stack 1319 can be used to route I/O signals from the conductive contacts 1336 to transistors 1340 and any other components integrated into the integrated circuit device (e.g., die) 1300.

Multiple integrated circuit devices 1300 may be stacked with one or more TSVs in the individual stacked devices providing connection between one of the devices to any of the other devices in the stack. For example, one or more high-bandwidth memory (HBM) integrated circuit dies can be stacked on top of a base integrated circuit die and TSVs in the HBM dies can provide connection between the individual HBM and the base integrated circuit die. Conductive contacts can provide additional connections between adjacent integrated circuit dies in the stack. In some embodiments, the conductive contacts can be fine-pitch solder bumps (microbumps).

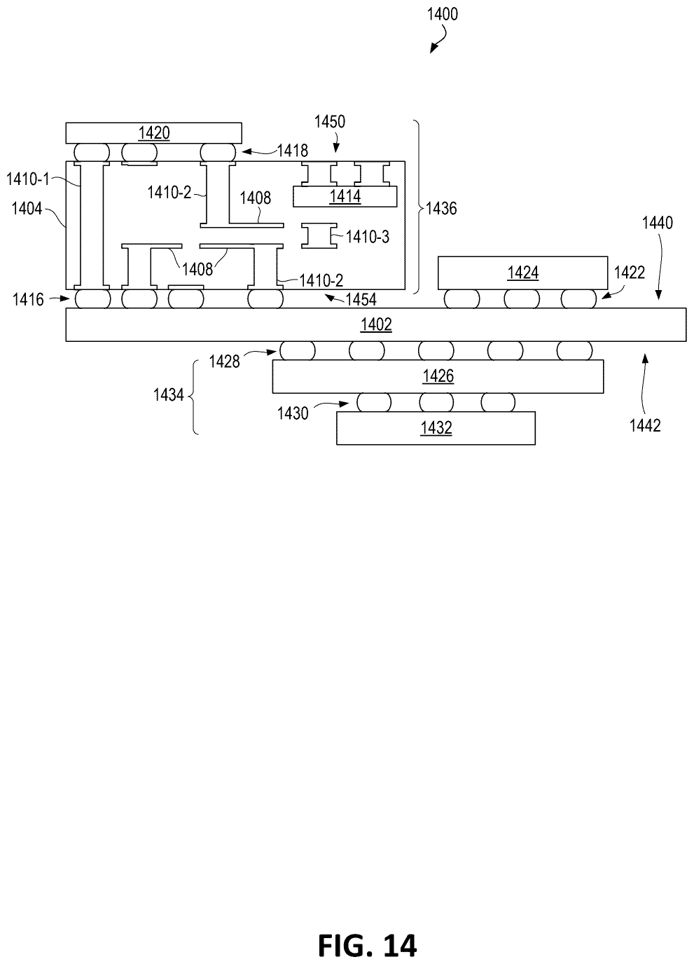

FIG. 14 is a cross-sectional side view of an integrated circuit device assembly 1400 that may include optical coupling devices, coupling features, PICs, EICs, XPUs, and/or other components as disclosed herein. In some embodiments, the integrated circuit device assembly 1400 may be a microelectronic assembly. The integrated circuit device assembly 1400 includes a number of components disposed on a circuit board 1402 (which may be a motherboard, system board, mainboard, etc.). The integrated circuit device assembly 1400 includes components disposed on a first face 1440 of the circuit board 1402 and an opposing second face 1442 of the circuit board 1402; generally, components may be disposed on one or both faces 1440 and 1442.

In some embodiments, the circuit board 1402 may be a printed circuit board (PCB) including multiple metal (or interconnect) layers separated from one another by layers of dielectric material and interconnected by electrically conductive vias. The individual metal layers comprise conductive traces. Any one or more of the metal layers may be formed in a desired circuit pattern to route electrical signals (optionally in conjunction with other metal layers) between the components coupled to the circuit board 1402. In other embodiments, the circuit board 1402 may be a non-PCB substrate. The integrated circuit device assembly 1400 illustrated in FIG. 14 includes a package-on-interposer structure 1436 coupled to the first face 1440 of the circuit board 1402 by coupling components 1416. The coupling components 1416 may electrically and mechanically couple the package-on-interposer structure 1436 to the circuit board 1402, and may include solder balls (as shown in FIG. 14), pins (e.g., as part of a pin grid array (PGA), contacts (e.g., as part of a land grid array (LGA)), male and female portions of a socket, an adhesive, an underfill material, and/or any other suitable electrical and/or mechanical coupling structure.

The package-on-interposer structure 1436 may include an integrated circuit component 1420 coupled to an interposer 1404 by coupling components 1418. The coupling components 1418 may take any suitable form for the application, such as the forms discussed above with reference to the coupling components 1416. Although a single integrated circuit component 1420 is shown in FIG. 14, multiple integrated circuit components may be coupled to the interposer 1404; indeed, additional interposers may be coupled to the interposer 1404. The interposer 1404 may provide an intervening substrate used to bridge the circuit board 1402 and the integrated circuit component 1420.

The integrated circuit component 1420 may be a packaged or unpackaged integrated circuit product that includes one or more integrated circuit dies (e.g., the die 1202 of FIG. 12, the integrated circuit device 1300 of FIG. 13) and/or one or more other suitable components. A packaged integrated circuit component comprises one or more integrated circuit dies mounted on a package substrate with the integrated circuit dies and package substrate encapsulated in a casing material, such as a metal, plastic, glass, or ceramic. In one example of an unpackaged integrated circuit component 1420, a single monolithic integrated circuit die comprises solder bumps attached to contacts on the die. The solder bumps allow the die to be directly attached to the interposer 1404. The integrated circuit component 1420 can comprise one or more computing system components, such as one or more processor units (e.g., system-on-a-chip (SoC), processor core, graphics processor unit (GPU), accelerator, chipset processor), I/O controller, memory, or network interface controller. In some embodiments, the integrated circuit component 1420 can comprise one or more additional active or passive devices such as capacitors, decoupling capacitors, resistors, inductors, fuses, diodes, transformers, sensors, electrostatic discharge (ESD) devices, and memory devices.

In embodiments where the integrated circuit component 1420 comprises multiple integrated circuit dies, the dies can be of the same type (a homogeneous multi-die integrated circuit component) or of two or more different types (a heterogeneous multi-die integrated circuit component). A multi-die integrated circuit component can be referred to as a multi-chip package (MCP) or multi-chip module (MCM).

In addition to comprising one or more processor units, the integrated circuit component 1420 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies can be referred to as “chiplets”. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof.

Generally, the interposer 1404 may spread connections to a wider pitch or reroute a connection to a different connection. For example, the interposer 1404 may couple the integrated circuit component 1420 to a set of ball grid array (BGA) conductive contacts of the coupling components 1416 for coupling to the circuit board 1402. In the embodiment illustrated in FIG. 14, the integrated circuit component 1420 and the circuit board 1402 are attached to opposing sides of the interposer 1404; in other embodiments, the integrated circuit component 1420 and the circuit board 1402 may be attached to a same side of the interposer 1404. In some embodiments, three or more components may be interconnected by way of the interposer 1404.

In some embodiments, the interposer 1404 may be formed as a PCB, including multiple metal layers separated from one another by layers of dielectric material and interconnected by electrically conductive vias. In some embodiments, the interposer 1404 may be formed of an epoxy resin, a fiberglass-reinforced epoxy resin, an epoxy resin with inorganic fillers, a ceramic material, or a polymer material such as polyimide. In some embodiments, the interposer 1404 may be formed of alternate rigid or flexible materials that may include the same materials described above for use in a semiconductor substrate, such as silicon, germanium, and other group III-V and group IV materials. The interposer 1404 may include metal interconnects 1408 and vias 1410, including but not limited to through hole vias 1410-1 (that extend from a first face 1450 of the interposer 1404 to a second face 1454 of the interposer 1404), blind vias 1410-2 (that extend from the first or second faces 1450 or 1454 of the interposer 1404 to an internal metal layer), and buried vias 1410-3 (that connect internal metal layers).

In some embodiments, the interposer 1404 can comprise a silicon interposer. Through silicon vias (TSV) extending through the silicon interposer can connect connections on a first face of a silicon interposer to an opposing second face of the silicon interposer. In some embodiments, an interposer 1404 comprising a silicon interposer can further comprise one or more routing layers to route connections on a first face of the interposer 1404 to an opposing second face of the interposer 1404.

The interposer 1404 may further include embedded devices 1414, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 1404. The package-on-interposer structure 1436 may take the form of any of the package-on-interposer structures known in the art.

The integrated circuit device assembly 1400 may include an integrated circuit component 1424 coupled to the first face 1440 of the circuit board 1402 by coupling components 1422. The coupling components 1422 may take the form of any of the embodiments discussed above with reference to the coupling components 1416, and the integrated circuit component 1424 may take the form of any of the embodiments discussed above with reference to the integrated circuit component 1420.

The integrated circuit device assembly 1400 illustrated in FIG. 14 includes a package-on-package structure 1434 coupled to the second face 1442 of the circuit board 1402 by coupling components 1428. The package-on-package structure 1434 may include an integrated circuit component 1426 and an integrated circuit component 1432 coupled together by coupling components 1430 such that the integrated circuit component 1426 is disposed between the circuit board 1402 and the integrated circuit component 1432. The coupling components 1428 and 1430 may take the form of any of the embodiments of the coupling components 1416 discussed above, and the integrated circuit components 1426 and 1432 may take the form of any of the embodiments of the integrated circuit component 1420 discussed above. The package-on-package structure 1434 may be configured in accordance with any of the package-on-package structures known in the art.

FIG. 15 is a block diagram of an example electrical device 1500 that may include optical coupling devices, optical features, PICs, EICs, XPUs, and/or other components as disclosed herein. For example, any suitable components of the electrical device 1500 may include one or more of the integrated circuit device assemblies 1400, integrated circuit components 1420, integrated circuit devices 1300, integrated circuit dies 1202, or other components disclosed herein. A number of components are illustrated in FIG. 15 as included in the electrical device 1500, but any one or more of these components may be omitted or duplicated, as suitable for the application. In some embodiments, some or all of the components included in the electrical device 1500 may be attached to one or more motherboards mainboards, or system boards. In some embodiments, one or more of these components are fabricated onto a single system-on-a-chip (SoC) die.

Additionally, in various embodiments, the electrical device 1500 may not include one or more of the components illustrated in FIG. 15, but the electrical device 1500 may include interface circuitry for coupling to the one or more components. For example, the electrical device 1500 may not include a display device 1506, but may include display device interface circuitry (e.g., a connector and driver circuitry) to which a display device 1506 may be coupled. In another set of examples, the electrical device 1500 may not include an audio input device 1524 or an audio output device 1508, but may include audio input or output device interface circuitry (e.g., connectors and supporting circuitry) to which an audio input device 1524 or audio output device 1508 may be coupled.

The electrical device 1500 may include one or more processor units 1502 (e.g., one or more processor units). As used herein, the terms “processor unit”, “processing unit” or “processor” may refer to any device or portion of a device that processes electronic data from registers and/or memory to transform that electronic data into other electronic data that may be stored in registers and/or memory. The processor unit 1502 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller cryptoprocessors (specialized processors that execute cryptographic algorithms within hardware), server processors, controllers, or any other suitable type of processor units. As such, the processor unit can be referred to as an XPU (or xPU).

The electrical device 1500 may include a memory 1504, which may itself include one or more memory devices such as volatile memory (e.g., dynamic random access memory (DRAM), static random-access memory (SRAM)), non-volatile memory (e.g., read-only memory (ROM), flash memory, chalcogenide-based phase-change non-voltage memories), solid state memory, and/or a hard drive. In some embodiments, the memory 1504 may include memory that is located on the same integrated circuit die as the processor unit 1502. This memory may be used as cache memory (e.g., Level 1 (L1), Level 2 (L2), Level 3 (L3), Level 4 (L4), Last Level Cache (LLC)) and may include embedded dynamic random access memory (eDRAM) or spin transfer torque magnetic random access memory (STT-MRAM).

In some embodiments, the electrical device 1500 can comprise one or more processor units 1502 that are heterogeneous or asymmetric to another processor unit 1502 in the electrical device 1500. There can be a variety of differences between the processing units 1502 in a system in terms of a spectrum of metrics of merit including architectural, microarchitectural, thermal, power consumption characteristics, and the like. These differences can effectively manifest themselves as asymmetry and heterogeneity among the processor units 1502 in the electrical device 1500.

In some embodiments, the electrical device 1500 may include a communication component 1512 (e.g., one or more communication components). For example, the communication component 1512 can manage wireless communications for the transfer of data to and from the electrical device 1500. The term “wireless” and its derivatives may be used to describe circuits, devices, systems, methods, techniques, communications channels, etc., that may communicate data through the use of modulated electromagnetic radiation through a nonsolid medium. The term “wireless” does not imply that the associated devices do not contain any wires, although in some embodiments they might not.

The communication component 1512 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 1512 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication component 1512 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication component 1512 may operate in accordance with Code Division Multiple Access (CDMA), Time Division Multiple Access (TDMA), Digital Enhanced Cordless

Telecommunications (DECT), Evolution-Data Optimized (EV-DO), and derivatives thereof, as well as any other wireless protocols that are designated as 3G, 4G, 5G, and beyond. The communication component 1512 may operate in accordance with other wireless protocols in other embodiments. The electrical device 1500 may include an antenna 1522 to facilitate wireless communications and/or to receive other wireless communications (such as amplitude modulation (AM) or frequency modulation (FM) radio transmissions).

In some embodiments, the communication component 1512 may manage wired communications, such as electrical, optical, or any other suitable communication protocols (e.g., IEEE 802.3 Ethernet standards). As noted above, the communication component 1512 may include multiple communication components. For instance, a first communication component 1512 may be dedicated to shorter-range wireless communications such as Wi-Fi or Bluetooth, and a second communication component 1512 may be dedicated to longer-range wireless communications such as global positioning system (GPS), EDGE, GPRS, CDMA, WiMAX, LTE, EV-DO, or others. In some embodiments, a first communication component 1512 may be dedicated to wireless communications, and a second communication component 1512 may be dedicated to wired communications.

The electrical device 1500 may include battery/power circuitry 1514. The battery/power circuitry 1514 may include one or more energy storage devices (e.g., batteries or capacitors) and/or circuitry for coupling components of the electrical device 1500 to an energy source separate from the electrical device 1500 (e.g., AC line power).

The electrical device 1500 may include a display device 1506 (or corresponding interface circuitry, as discussed above). The display device 1506 may include one or more embedded or wired or wirelessly connected external visual indicators, such as a heads-up display, a computer monitor, a projector, a touchscreen display, a liquid crystal display (LCD), a light-emitting diode display, or a flat panel display.

The electrical device 1500 may include an audio output device 1508 (or corresponding interface circuitry, as discussed above). The audio output device 1508 may include any embedded or wired or wirelessly connected external device that generates an audible indicator, such speakers, headsets, or earbuds.

The electrical device 1500 may include an audio input device 1524 (or corresponding interface circuitry, as discussed above). The audio input device 1524 may include any embedded or wired or wirelessly connected device that generates a signal representative of a sound, such as microphones, microphone arrays, or digital instruments (e.g., instruments having a musical instrument digital interface (MIDI) output). The electrical device 1500 may include a Global Navigation Satellite System (GNSS) device 1518 (or corresponding interface circuitry, as discussed above), such as a Global Positioning System (GPS) device. The GNSS device 1518 may be in communication with a satellite-based system and may determine a geolocation of the electrical device 1500 based on information received from one or more GNSS satellites, as known in the art.

The electrical device 1500 may include an other output device 1510 (or

corresponding interface circuitry, as discussed above). Examples of the other output device 1510 may include an audio codec, a video codec, a printer, a wired or wireless transmitter for providing information to other devices, or an additional storage device.

The electrical device 1500 may include an other input device 1520 (or corresponding interface circuitry, as discussed above). Examples of the other input device 1520 may include an accelerometer, a gyroscope, a compass, an image capture device (e.g., monoscopic or stereoscopic camera), a trackball, a trackpad, a touchpad, a keyboard, a cursor control device such as a mouse, a stylus, a touchscreen, proximity sensor, microphone, a bar code reader, a Quick Response (QR) code reader, electrocardiogram (ECG) sensor, PPG (photoplethysmogram) sensor, galvanic skin response sensor, any other sensor, or a radio frequency identification (RFID) reader.

The electrical device 1500 may have any desired form factor, such as a hand-held or mobile electrical device (e.g., a cell phone, a smart phone, a mobile internet device, a music player, a tablet computer, a laptop computer, a 2-in-1 convertible computer, a portable all-in-one computer, a netbook computer, an ultrabook computer, a personal digital assistant (PDA), an ultra mobile personal computer, a portable gaming console, etc.), a desktop electrical device, a server, a rack-level computing solution (e.g., blade, tray or sled computing systems), a workstation or other networked computing component, a printer, a scanner, a monitor, a set-top box, an entertainment control unit, a stationary gaming console, smart television, a vehicle control unit, a digital camera, a digital video recorder, a wearable electrical device or an embedded computing system (e.g., computing systems that are part of a vehicle, smart home appliance, consumer electronics product or equipment, manufacturing equipment). In some embodiments, the electrical device 1500 may be any other electronic device that processes data. In some embodiments, the electrical device 1500 may comprise multiple discrete physical components. Given the range of devices that the electrical device 1500 can be manifested as in various embodiments, in some embodiments, the electrical device 1500 can be referred to as a computing device or a computing system.

Although the FIGS. depict specific embodiments of various components, any particular embodiment of a component may utilize one or more characteristics illustrated or described with respect to a similar component of another FIG. As just one example, a coupling feature may include any suitable characteristics of any one or more of the illustrated or described coupling features.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

It will also be understood that, although the terms “first,” “second,” and so forth may be used herein to describe various elements, these elements should not be limited by these terms. These terms are only used to distinguish one element from another, and are not intended to imply that the objects so described must be in a given sequence, either temporally, spatially, in ranking or in any other manner. For example, a first contact could be termed a second contact, and, similarly, a second contact could be termed a first contact, without departing from the scope of the present example embodiments. The first contact and the second contact are both contacts, but they are not the same contact.

As used in the description of the example embodiments and the appended examples, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. For example, the phrase “A and/or B” means (A), (B), or (A and B), while the phrase “A, B, and/or C” means (A), (B), (C), (A and B), (A and C), (B and C), or (A, B, and C).

As used throughout this description, and in the claims, a list of items joined by the term “at least one of” or “one or more of” can mean any combination of the listed terms.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, the terms “comprising,” “including,” “having,” and the like, as used with respect to embodiments of the present disclosure, are synonymous.

The description may use the phrases “in an embodiment,” “according to some embodiments,” “in accordance with embodiments,” or “in embodiments,” which may each refer to one or more of the same or different embodiments.

As used herein, the term “module” refers to being part of, or including an ASIC, an electronic circuit, a system on a chip, a processor (shared, dedicated, or group), a solid state device, a memory (shared, dedicated, or group) that execute one or more software or firmware programs, a combinational logic circuit, and/or other suitable components that provide the described functionality.

As used herein, “electrically conductive” in some examples may refer to a property of a material having an electrical conductivity greater than or equal to 10⁷ Siemens per meter (S/m) at 20 degrees Celsius. Examples of such materials include Cu, Ag, Al, Au, W, Zn and Ni.

The term “signal” may refer to at least one current signal, voltage signal, magnetic signal, or data/clock signal.

Throughout the specification, and in the claims, the term “connected” means a direct connection, such as electrical, mechanical, or magnetic connection between the elements that are connected, without any intermediary devices. The term “coupled” means a direct or indirect connection, such as a direct electrical, mechanical, or magnetic connection between the elements that are connected or an indirect connection, through one or more passive or active intermediary devices.

The description may use perspective-based descriptions such as top/bottom, in/out, over/under, and the like. Such descriptions are merely used to facilitate the discussion and are not intended to restrict the application of embodiments described herein to any particular orientation.

The terms “over,” “under,” “between,” and “on” as used herein refer to a relative position of one component or material with respect to other components or materials where such physical relationships are noteworthy. For example, in the context of materials, one material or layer over or under another may be directly in contact or may have one or more intervening materials or layers. Moreover, one material between two materials or layers may be directly in contact with the two materials/layers or may have one or more intervening materials/layers. In contrast, a first material or layer “on” a second material or layer means that at least a part of the first material or layer is in direct physical contact with at least a part of that second material/layer. Similar distinctions are to be made in the context of component assemblies.

As used herein, “A is proximate to B” may mean that A is adjacent to B or A is otherwise near to B.

Unless otherwise specified in the specific context of use, the term “predominantly” means more than 50%, or more than half. For example, a composition that is predominantly a first constituent means more than half of the composition (e.g., by volume) is the first constituent (e.g., >50 at. %). The term “primarily” means the most, or greatest, part. For example, a composition that is primarily a first constituent means the composition has more of the first constituent (e.g., by volume) than any other constituent. A composition that is primarily first and second constituents means the composition has more of the first and second constituents than any other constituent. The term “substantially” means there is only incidental variation. For example, composition that is substantially a first constituent means the composition may further include <1% of any other constituent. A composition that is substantially first and second constituents means the composition may further include <1% of any constituent substituted for either the first or second constituent.

The terms “substantially,” “close,” “approximately,” “near,” and “about,” generally refer to being within +/−10% of a target value (unless specifically specified).

Unless otherwise specified in the explicit context of their use, the terms “substantially equal,” “about equal” or “approximately equal” mean that there is no more than incidental variation between two things so described. In the art, such variation is typically no more than +/−10% of a predetermined target value.

In the corresponding drawings of the embodiments, signals, currents, electrical biases, or magnetic or electrical polarities may be represented with lines. Some lines may be thicker, to indicate more constituent signal paths, and/or have arrows at one or more ends, to indicate primary information flow direction. Such indications are not intended to be limiting. Rather, the lines are used in connection with one or more exemplary embodiments to facilitate easier understanding of a circuit or a logical unit. Any represented signal, polarity, current, voltage, etc., as dictated by design needs or preferences, may actually comprise one or more signals that may travel in either direction and may be implemented with any suitable type of signal scheme.

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

Although the figures may illustrate embodiments where structures are substantially aligned to Cartesian axes (e.g., device structures having substantially vertical sidewalls), positive and negative (re-entrant) sloped feature sidewalls often occur in practice. For example, manufacturing non-idealities may cause one or more structural features to have sloped sidewalls. Thus, attributes illustrated are idealized merely for the sake of clearly describing salient features. It is to be understood that schematic illustrations may not reflect real-life process limitations which may cause the features to not look so “ideal” when any of the structures described herein are examined using e.g., scanning electron microscopy (SEM) images or transmission electron microscope (TEM) images. In such images of real structures, possible processing defects could also be visible, e.g., not-perfectly straight edges of materials, tapered vias or other openings, inadvertent rounding of corners or variations in thicknesses of different material layers, occasional screw, edge, or combination dislocations within the crystalline region, and/or occasional dislocation defects of single atoms or clusters of atoms. There may be other defects not listed here but that are common within the field of device fabrication.

Illustrative examples of the technologies described throughout this disclosure are provided below. Embodiments of these technologies may include any one or more, and any combination of, the examples described below. In some embodiments, at least one of the systems or components set forth in one or more of the preceding figures may be configured to perform one or more operations, techniques, processes, and/or methods as set forth in the following examples.

Example 1 includes an apparatus comprising a die comprising a photonic integrated circuit, the die comprising a first plurality of optical channels; an optical coupling device attached to the die, the optical coupling device comprising a second plurality of optical channels, the first plurality of optical channels communicatively coupled to the second plurality of optical channels; and a coupler attached to the optical coupling device and to at least one of the die and a package substrate attached to the die.

Example 2 includes the subject matter of Example 1, and wherein the coupler is attached to the package substrate.

Example 3 includes the subject matter of any of Examples 1 and 2, and wherein the coupler is attached to the die.

Example 4 includes the subject matter of any of Examples 1-3, and wherein the coupler is attached to an integrated heat spreader.

Example 5 includes the subject matter of any of Examples 1-4, and wherein the coupler is attached to the optical coupling device by an adhesive material.

Example 6 includes the subject matter of any of Examples 1-5, and wherein the coupler is attached to the optical coupling device by solder.

Example 7 includes the subject matter of any of Examples 1-6, and wherein the coupler comprises a shelf to interface with a surface of the optical coupling device.

Example 8 includes the subject matter of any of Examples 1-7, and wherein the coupler comprises a cavity filled with a bonding material and the bonding material is in contact with the optical coupling device.

Example 9 includes the subject matter of any of Examples 1-8, and wherein the cavity is closed on an end that is closest to an integrated heat sink.

Example 10 includes the subject matter of any of Examples 1-9, and wherein the cavity is open on an end that is closest to an integrated heat sink.

Example 11 includes the subject matter of any of Examples 1-10, and wherein the coupler includes a first portion and second portions extending from the first portion on respective sides of the first portion, wherein the second portions are attached to respective sides of the die.

Example 12 includes the subject matter of any of Examples 1-11, and further including a second coupler attached to the optical coupling device and to at least one of the die and the package substrate.

Example 13 includes the subject matter of any of Examples 1-12, and wherein the optical coupling device comprises at least one block comprising glass; and a plurality of optical fibers, wherein the optical fibers are encased within the at least one block along a portion of a length of the plurality of optical fibers, the plurality of optical fibers comprising first ends connected to an optical connector and second ends extending from the at least one block.

Example 14 includes the subject matter of any of Examples 1-13, wherein the optical coupling device comprises a plurality of waveguides within at least one block comprising glass.

Example 15 includes a system comprising a package substrate; a photonic integrated circuit; a first coupler comprising at least one rigid portion; and a plurality of optical channels within the at least one rigid portion; and a second coupler comprising a rigid material, wherein the second coupler is attached to the first coupler and to at least one of the photonic integrated circuit and the package substrate.

Example 16 includes the subject matter of Example 15, and further including a processor coupled to the package substrate and the photonic integrated circuit.

Example 17 includes the subject matter of any of Examples 15 and 16, and further including a printed circuit board coupled to the package substrate.

Example 18 includes the subject matter of any of Examples 15-17, and further including a battery, display, or network interface communicatively coupled to the processor through the printed circuit board.

Example 19 includes the subject matter of any of Examples 15-18, and wherein the second coupler is attached to the package substrate.

Example 20 includes the subject matter of any of Examples 15-19, and wherein the second coupler is attached to the photonic integrated circuit.

Example 21 includes the subject matter of any of Examples 15-20, and wherein the second coupler is attached to an integrated heat spreader.

Example 22 includes the subject matter of any of Examples 15-21, and wherein the second coupler is attached to the first coupler by an adhesive material.

Example 23 includes the subject matter of any of Examples 15-22, and wherein the second coupler is attached to the first coupler by solder.

Example 24 includes the subject matter of any of Examples 15-23, and wherein the second coupler comprises a shelf to interface with a surface of the first coupler.

Example 25 includes the subject matter of any of Examples 15-24, and wherein the second coupler comprises a cavity filled with a bonding material and the bonding material is in contact with the first coupler.

Example 26 includes the subject matter of any of Examples 15-25, and wherein the cavity is closed on an end that is closest to an integrated heat sink.

Example 27 includes the subject matter of any of Examples 15-26, and wherein the cavity is open on an end that is closest to an integrated heat sink.

Example 28 includes the subject matter of any of Examples 15-27, and wherein the second coupler includes a first portion and second portions extending from the first portion on respective sides of the first portion, wherein the second portions are attached to respective sides of the photonic integrated circuit.

Example 29 includes the subject matter of any of Examples 15-28, and further including a third coupler attached to the first coupler and to at least one of the photonic integrated circuit and the package substrate.

Example 30 includes the subject matter of any of Examples 15-29, and wherein the first coupler comprises at least one block comprising glass; and a plurality of optical fibers, wherein the optical fibers are encased within the at least one block along a portion of a length of the plurality of optical fibers, the plurality of optical fibers comprising first ends connected to an optical connector and second ends extending from the at least one block.

Example 31 includes the subject matter of any of Examples 15-30, and wherein the first coupler comprises a plurality of waveguides within at least one block comprising glass.

Example 32 includes an apparatus comprising a die comprising a photonic integrated circuit, the die comprising a first plurality of optical channels; an optical coupling device, the optical coupling device comprising a second plurality of optical channels aligned with the first plurality of optical channels; and a mechanical coupler attached to the optical coupling device and to at least one of the die and a package substrate attached to the die.

Example 33 includes the subject matter of Example 32, and wherein the mechanical coupler comprises at least one of ceramic, metal, and glass.

Example 34 includes the subject matter of any of Examples 32 and 33, and wherein the mechanical coupler is attached to the package substrate.

Example 35 includes the subject matter of any of Examples 32-34, and wherein the mechanical coupler is attached to the die.

Example 36 includes the subject matter of any of Examples 32-35, and wherein the mechanical coupler is attached to an integrated heat spreader.

Example 37 includes the subject matter of any of Examples 32-36, and wherein the mechanical coupler is attached to the optical coupling device by an adhesive material.

Example 38 includes the subject matter of any of Examples 32-37, and wherein the mechanical coupler is attached to the optical coupling device by solder.

Example 39 includes the subject matter of any of Examples 32-38, and wherein the mechanical coupler comprises a shelf to interface with a surface of the optical coupling device.

Example 40 includes the subject matter of any of Examples 32-39, and wherein the mechanical coupler comprises a cavity filled with a bonding material and the bonding material is in contact with the optical coupling device.

Example 41 includes the subject matter of any of Examples 32-40, and wherein the cavity is closed on an end that is closest to an integrated heat sink.

Example 42 includes the subject matter of any of Examples 32-41, and wherein the cavity is open on an end that is closest to an integrated heat sink.

Example 43 includes the subject matter of any of Examples 32-42, and wherein the mechanical coupler includes a first portion and second portions extending from the first portion on respective sides of the first portion, wherein the second portions are attached to respective sides of the die.

Example 44 includes the subject matter of any of Examples 32-43, and further including a second mechanical coupler attached to the optical coupling device and to at least one of the die and the package substrate.

Example 45 includes the subject matter of any of Examples 32-44, and wherein the optical coupling device comprises at least one block comprising glass; and a plurality of optical fibers, wherein the optical fibers are encased within the at least one block along a portion of a length of the plurality of optical fibers, the plurality of optical fibers comprising first ends connected to an optical connector and second ends extending from the at least one block.

Example 46 includes the subject matter of any of Examples 32-45, and wherein the optical coupling device comprises a plurality of waveguides within at least one block comprising glass.

Example 47 includes a method comprising attaching a die to a package substrate, the die comprising a photonic integrated circuit, the die comprising a first plurality of optical channels; attaching an optical coupling device to the die to align a second plurality of optical channels of the optical coupling device to the first plurality of optical channels; and attaching a coupler to the optical coupling device and to at least one of the die and the package substrate.

Example 48 includes the subject matter of Example 47, and wherein the coupler is attached to the package substrate.

Example 49 includes the subject matter of any of Examples 47 and 48, and wherein the coupler is attached to the die.

Example 50 includes the subject matter of any of Examples 47-49, and further including attaching the coupler to an integrated heat spreader.

Example 51 includes the subject matter of any of Examples 47-50, and further including attaching the coupler to the optical coupling device by an adhesive material.

Example 52 includes the subject matter of any of Examples 47-51, and further including attaching the coupler to the optical coupling device by solder.

Example 53 includes the subject matter of any of Examples 47-52, and wherein the coupler comprises a shelf to interface with a surface of the optical coupling device.

Example 54 includes the subject matter of any of Examples 47-53, and wherein the coupler comprises a cavity filled with a bonding material and the bonding material is in contact with the optical coupling device.

Example 55 includes the subject matter of any of Examples 47-54, and wherein the cavity is closed on an end that is closest to an integrated heat sink.

Example 56 includes the subject matter of any of Examples 47-55, and wherein the cavity is open on an end that is closest to an integrated heat sink.

Example 57 includes the subject matter of any of Examples 47-56, and wherein the coupler includes a first portion and second portions extending from the first portion on respective sides of the first portion, wherein the second portions are attached to respective sides of the die.

Example 58 includes the subject matter of any of Examples 47-57, and further including attaching a second coupler to the optical coupling device and to at least one of the die and the package substrate.

Example 59 includes the subject matter of any of Examples 47-58, and wherein the optical coupling device comprises at least one block comprising glass; and a plurality of optical fibers, wherein the optical fibers are encased within the at least one block along a portion of a length of the plurality of optical fibers, the plurality of optical fibers comprising first ends connected to an optical connector and second ends extending from the at least one block.

Example 60 includes the subject matter of any of Examples 47-59, and wherein the optical coupling device comprises a plurality of waveguides within at least one block comprising glass.

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

1. An apparatus comprising:
a die comprising a photonic integrated circuit, the die comprising a first plurality of optical channels;
an optical coupling device attached to the die, the optical coupling device comprising a second plurality of optical channels, the first plurality of optical channels communicatively coupled to the second plurality of optical channels; and
a coupler attached to the optical coupling device and to at least one of the die and a package substrate attached to the die.

2. The apparatus of claim 1, wherein the coupler is attached to the package substrate.

3. The apparatus of claim 1, wherein the coupler is attached to the die.

4. The apparatus of claim 1, wherein the coupler is attached to an integrated heat spreader.

5. The apparatus of claim 1, wherein the coupler is attached to the optical coupling device by an adhesive material.

6. The apparatus of claim 1, wherein the coupler is attached to the optical coupling device by solder.

7. The apparatus of claim 1, wherein the coupler comprises a shelf to interface with a surface of the optical coupling device.

8. The apparatus of claim 1, wherein the coupler comprises a cavity filled with a bonding material and the bonding material is in contact with the optical coupling device.

9. The apparatus of claim 8, wherein the cavity is closed on an end that is closest to an integrated heat sink.

10. The apparatus of claim 8, wherein the cavity is open on an end that is closest to an integrated heat sink.

11. The apparatus of claim 1, wherein the coupler includes a first portion and second portions extending from the first portion on respective sides of the first portion, wherein the second portions are attached to respective sides of the die.

12. The apparatus of claim 1, further comprising a second coupler attached to the optical coupling device and to at least one of the die and the package substrate.

13. The apparatus of claim 1, wherein the optical coupling device comprises:
at least one block comprising glass; and
a plurality of optical fibers, wherein the optical fibers are encased within the at least one block along a portion of a length of the plurality of optical fibers, the plurality of optical fibers comprising first ends connected to an optical connector and second ends extending from the at least one block.

14. The apparatus of claim 1, wherein the optical coupling device comprises a plurality of waveguides within at least one block comprising glass.

15. A system comprising:
a package substrate;
a photonic integrated circuit;
a first coupler comprising:
at least one rigid portion; and
a plurality of optical channels within the at least one rigid portion; and
a second coupler comprising a rigid material, wherein the second coupler is attached to the first coupler and to at least one of the photonic integrated circuit and the package substrate.

16. The system of claim 15, further comprising a processor coupled to the package substrate and the photonic integrated circuit.

17. The system of claim 16, further comprising a printed circuit board coupled to the package substrate.

18. The system of claim 17, further comprising a battery, display, or network interface communicatively coupled to the processor through the printed circuit board.

19. An apparatus comprising:
a die comprising a photonic integrated circuit, the die comprising a first plurality of optical channels;
an optical coupling device, the optical coupling device comprising a second plurality of optical channels aligned with the first plurality of optical channels; and
a mechanical coupler attached to the optical coupling device and to at least one of the die and a package substrate attached to the die.

20. The apparatus of claim 19, wherein the mechanical coupler comprises at least one of ceramic, metal, and glass.
